(19) United States
(12) Patent Application Publication
(10) Pub. No.: US 2009/0055266 A1
(43) Pub. Date: Feb. 26, 2009

(54) SUBSCRIPTION PROMOTION AND MANAGEMENT SYSTEM AND METHOD

(76) Inventors: Edward BRODY, Washington, DC (US); William Lynch, Washington, DC (US); Robert Kerner, Ashburn, VA (US)

Correspondence Address: DLA PIPER LLP US, P. O. BOX 2758, RESTON, VA, 20195, US

(21) Appl. No.: 12/125,703

(22) Filed: May 22, 2008

Related U.S. Application Data
(60) Provisional application No. 60/939,971, filed on May 24, 2007.

(51) Int. Cl. G06Q 30/00

(52) U.S. Cl. 705/14; 705/30; 705/34

(57) ABSTRACT

A method of, and system for, facilitating electronic commerce transaction comprises: steps for, or server component, receiving an indication of purchase of a first product from a first seller, sending an offer for a second product of a second seller to the first seller, allowing the first seller to accept and complete purchase of the second product without providing billing information of the customer to the second seller. The method and system may further provide a subscription management of multiple subscriptions from different subscription sellers.

### CROSS-REFERENCE TO RELATED APPLICATIONS

This application claims the benefit of U.S. Provisional Application No. 60/939,971, filed on May 24, 2007, the disclosure of which is incorporated herein by reference in its entirety.

### FIELD OF THE INVENTION

The present invention is directed to a computer system and method of operation of a computer system that provides promotion and management of subscription based services and/or products.

### BRIEF DESCRIPTION OF THE DRAWINGS

Embodiments of the invention are described by way of example with reference to the accompanying drawings in which like numbers correspond to like elements, and in which:

FIG. 1 is a block diagram of an example computer network usable in practicing embodiments of the present invention;

FIG. 2A is a block diagram showing the relevant portions of a subscription promotion and management server according to an embodiment of the invention;

FIG. 2B is a block diagram illustrating the communication interfaces between the subscription promotion and management server and the participants of services provided by the same according to an embodiment of the invention;

FIG. 3 is a flow diagram illustrating the process of cross-marketing of products according to an embodiment of the invention;

FIG. 3A illustrates an example of cross-selling offer of a second product being embedded in a purchase confirmation page for a first product according to an embodiment of the invention;

FIG. 3B illustrates an example of a second seller web interface for the cross-selling offer of a second product according to an embodiment of the invention;

FIG. 3C illustrates reduced user action steps when practicing an embodiment of the invention;

FIG. 4 illustrates an example of cross-marketing process flow according to an embodiment of the invention;

FIG. 5 illustrates an example of service activation process flow according to an embodiment of the invention;

FIG. 6 illustrates an example of service management process flow according to an embodiment of the invention;

FIGS. 6A through 6F illustrates user interfaces provided during a service management session according to an embodiment of the invention;

FIG. 7 illustrates an example use scenario of a cross-marketing process according to an embodiment of the invention;

FIG. 8 illustrates an example use scenario of a purchasing of cross-marketed product process according to an embodiment of the invention; and

FIG. 9 illustrates an example use scenario of a subscription account management process according to an embodiment of the invention.

### DETAILED DESCRIPTION OF VARIOUS EMBODIMENTS OF THE INVENTION

Reference will now be made in detail to the embodiments of the present invention, examples of which are illustrated in the accompanying drawings, wherein like reference numerals refer to like elements throughout.

Various aspects and embodiments will be described. One embodiment is herein after referred to as the “Subscription Promotion and Management System (SPMS).” It should be noted that, for the purpose of providing an illustration of the benefits and advantages of many aspects of the invention, an example type of e-commerce, namely the on-line commerce of subscription based products and/or services, is used throughout this specification. However, the scope of the application of the systems and methods described herein should not be so limited to only subscription related commerce. It should be also noted that while the application of e-commerce is generally directed to the exchange of monetary fees for goods and services, it is not necessary that there is actual payment for the goods and services. That is, the presently described system and methods can also be applied for free membership or subscription services.

In one aspect of the systems and methods described herein, e-commerce may be made more efficient and effective by linking companies that provide goods and services (e.g., “Suppliers”) to companies with existing consumer e-commerce relationships (e.g., “Distributors”).

In another aspect, increased awareness of products and services available in the market place can be achieved by directing to a potential customer, who has just purchased a product and/or service, a cross-sell offer of a related product and/or service. Thus, for example products and/or services can be marketed to people that may already have reasons to be interested.

In yet another aspect, the rate of conversion to sale for the cross-sell offer can be increased by providing the buyer with a convenient and safe purchase process that may not require reentering of the buyers user and/or billing information. Thus, for example, impulse buys can be increased. Customers may not be required to enter in additional information (e.g., name, address, telephone, email, credit card numbers) to make an additional purchase, which may result in saving of time, and which may address buyer inconvenience and security concerns.

In a yet another aspect, a centralized user account management may alleviate the need for wasteful resources of maintaining user account records by an individual Supplier or a Distributor. Thus, for example, resources such as equipment and man-hours, security feature (e.g., accidental erasure, identity theft, breach of privacy), and administrative resources (e.g. billing, collection, tracking expiration, service level, etc. of subscribers) can be used efficiently.

The centralized user account management system may also provide the convenience of being able to manage multiple accounts from one location to the users. For example, when the subscriber/user subscribes to one or more other products and/or service, in order to manage the subscriptions, e.g., to cancel, renew, or change the level of the service, or the like, the subscriber may not be required to log onto the individual service provider's website to access the account information, having to memorize yet another login information, new website address, a new and unfamiliar web interface.

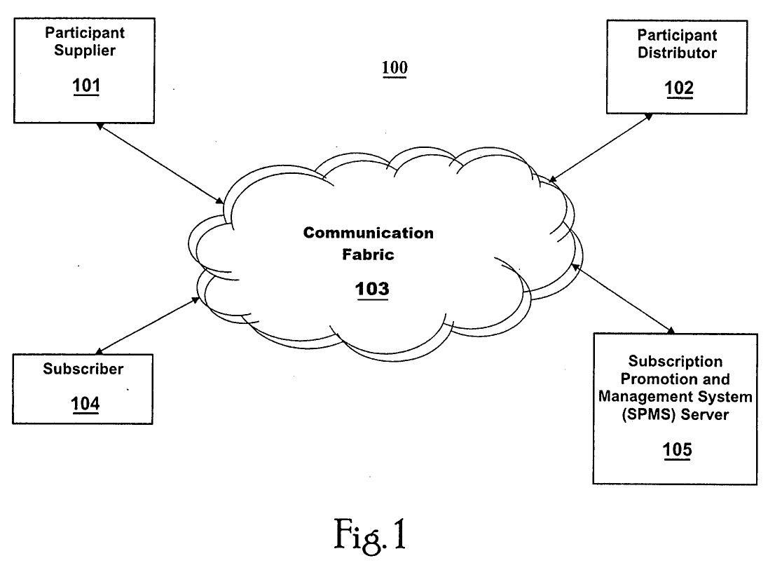

Referring now to FIG. 1, the SPMS 100 may include one or more suppliers 101 participating in the services of the SPMS 100 and one or more distributors 102 participating in the service, connected to the SPMS server though the use of the communication fabric 103. While only one supplier and only one distributor are shown in FIG. 1, it should be understood that there may be any number of suppliers and distributors participating, and that a supplier can also act as a distributor, i.e., each participant could play a dual role.

The communication fabric 103 may be any variety of network, e.g., a wide area network (WAN), and may comprise a plurality of computers, routers, gateways and/or portions of the Public Switched Telephone Network (PSTN), as known to those familiar with the architecture of wide area networks, e.g., the Internet.

Also shown in FIG. 1 is the subscriber 104, which is a user/consumer of the services offered through the SPMS 100. The subscriber 104 may use a computer terminal, e.g., a personal computer (PC), personal data assistant (PDA), cellular phone, Internet-enabled television, or any other device capable of communicating, and otherwise accessing the services provided by the SPMS 100. Again, while only one subscriber is shown, there may be any number of subscribers.

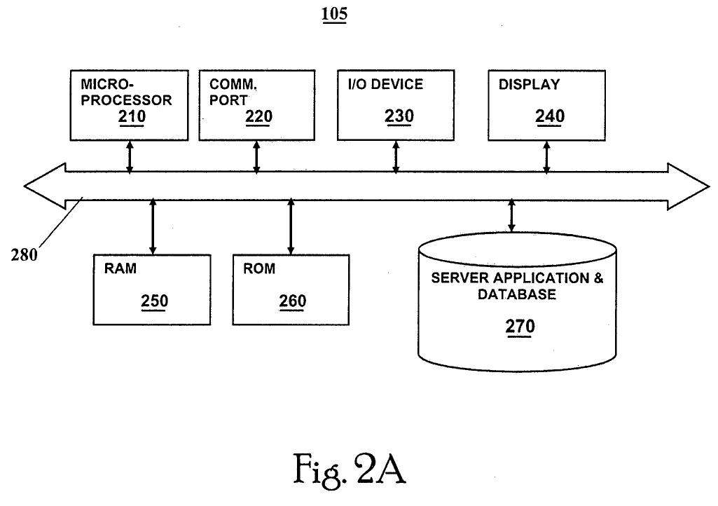

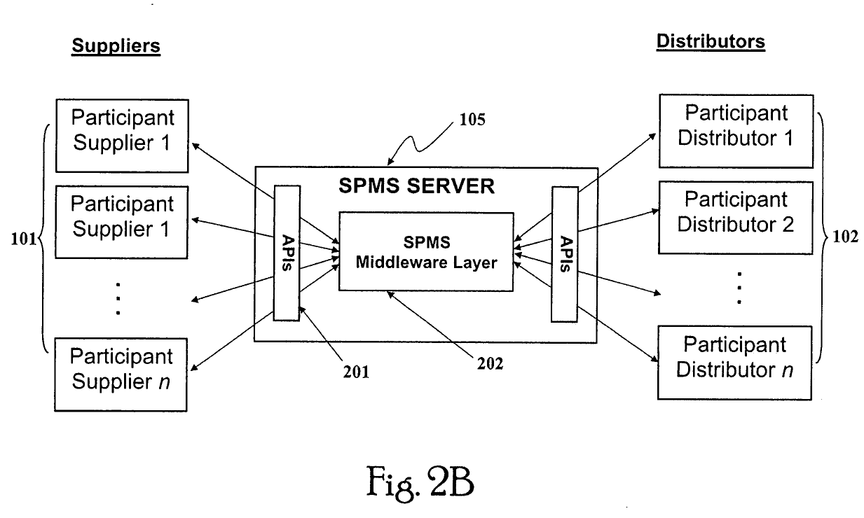

The SPMS server 105 may communicate with each of the participant(s), supplier(s) and subscriber(s) through the communication fabric 103, to provide the SPMS services described herein. The SPMS server 105 may be a computer, such as including, e.g., a personal computer (PC), a main frame computer or the like. An example of such computer is shown in FIG. 2A.

For example, the SPMS server 105 may include microprocessor 210 in communication with bus 280. Microprocessor 210 may be a Pentium™, RISC™-based, or other type of processor and is used to execute processor-executable process steps so as to control the components of the SPMS server 105 to provide desired functionality.

Also in communication with bus 280 is communication port 220. The communication port 220 may be used to transmit data to and to receive data from the communication fabric 104. In one embodiment, the communication port 220 may be a modem, Ethernet device, or a TCP/IP communications device or the like.

The I/O device 230 and the display 240 may also be in communication with the bus 280. The I/O device may be any known human-to-computer interface device, including a keyboard, mouse, trackball. touch pad, voice-recognition system, or any combination of these devices. The I/O device 230 may be used by an operator of the SPMS server 105 to input commands or data. The display 240 may be an integral or separate CRT display, flat-panel display or the like. The display 240 may be used to output graphics and text to an operator of the SPMS server 105.

The random access memory (RAM) 250 may be connected to bus 280 to provide microprocessor 210 with data storage during operation. The read-only-memory (ROM) 260 provides a pseudo permanent storage that is not erased even when the power to the SPMS server 105 is removed. The ROM 260 may also store some of the instructions to be executed by the microprocessor 210.

Data storage device 270 stores, among other data, processor-executable process steps of the SPMS server 105. Microprocessor 210 may execute instructions of SPMS server 105 to cause the SPMS server 105 to operate in accordance with the process steps described in detail herein. The data storage 270 may also included processor-executable process steps to cause the SPMS server 105 to operate as a World Wide Web (WWW) server.

Also, a database of transaction data, user/subscriber account data, or the like collected in the manner described in detail herein, may be stored in the data storage device 270.

While in the described embodiment one SPMS server 105 is shown and described as implementing the SPMS services, some of or all of these services may be implemented by several server(s).

As shown in FIG. 2B, in which, for the sake of brevity, the communication fabric 103 and subscriber 104 are omitted, the communications between the SPMS server and each of the Suppliers and Distributors may be carried out using the Application Program Interfaces (APIs), which will be described in greater detail later. The SPMS middleware layer 202 may perform the operations implementing the various applications for the SPMS services, which will be further described later.

According to an aspect of the embodiment, a participant distributor 102 can, in conjunction with SPMS 100, promote third party products and/or services on its purchase confirmation page, and share customer billing information when requested by the consumer. According to another aspect, a participant supplier 101, in conjunction with SPMS 100, may be able to market, sell and bill for its services through the SPMS Web store front, and through SPMS's network of participant distributors 102.

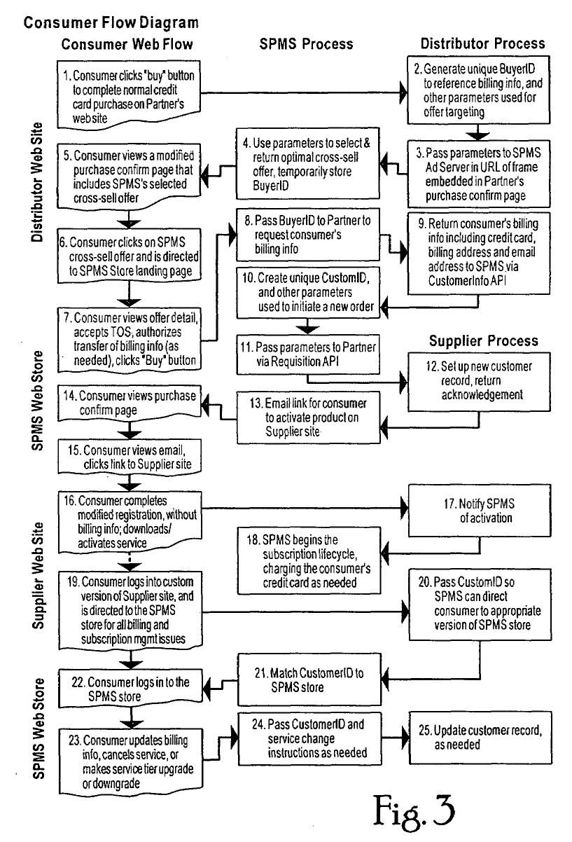

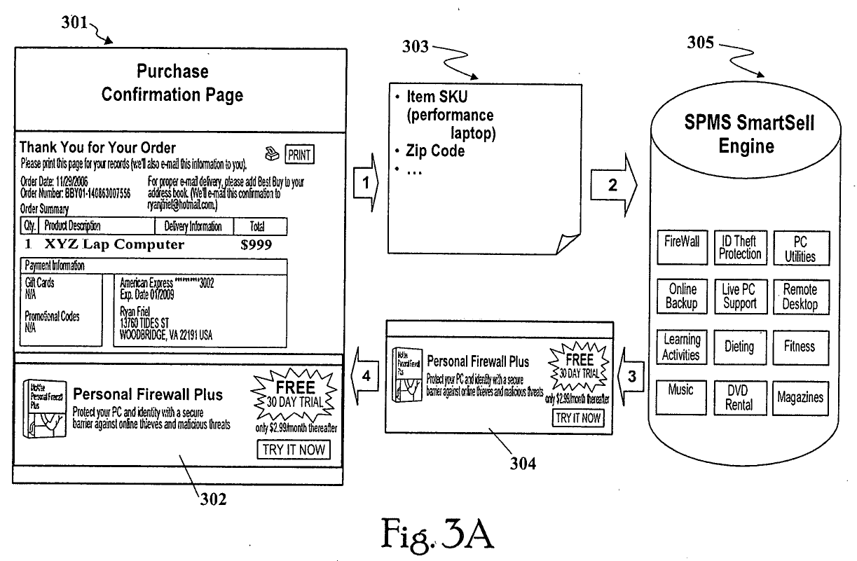

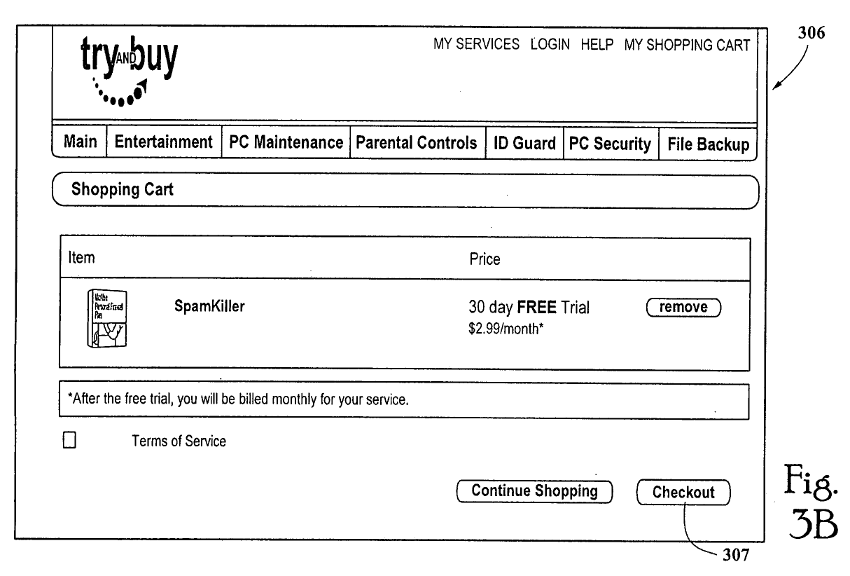

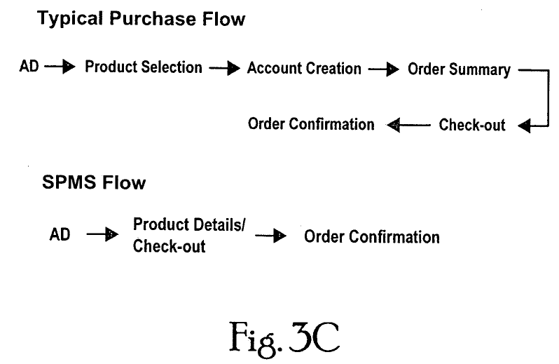

Shown in FIG. 3 is a flow diagram of an example of interactions between a subscriber/consumer 104, a supplier 101, a distributor 102 and the SPMS server 105. In step 1, the subscriber/consumer 104 may be in the process of completing a purchase from a distributor's website, and may be provided by the distributor with a purchase confirmation page 301.

An example illustration of such purchase confirmation page 301 is shown in FIG. 3A. In step 2, the distributor 102 may assign a unique identification for the customer, and gathers relevant information about the current purchase. As shown in FIG. 3A, the relevant information can be, for example, the item stock keeping unit (SKU) number for the product being purchased, the zone improvement plan (ZIP) code for the customer's address, or the like. The distributor 102 then in step 3 sends the purchase related information to SPMS server 105. The distributor may additionally pass to the SPMS server 105 the information relating to the frame available in the purchase confirmation page for a cross-sell offer advertisement.

In step 3, SPMS server 105 receives the information from the distributor 102, and may use the same to select from a catalog of products and services that may be of interest to the customer in light of the current purchase. In an embodiment, there may be provided a SmartSell Engine 305 (FIG. 3A), which may include a catalog of products and services of various categories, and which may additionally include algorithms for finding the matching product from the catalog. There may be a number of ways to find the matching product. One example may be based on a historic knowledge base of what other consumers have also bought when purchasing a product or service.

The SPMS sever 105, in step 4, may generate a cross-sell offer advertisement 304 containing the selected cross-sell product, e.g., in the form of a web page frame, using, e.g., the information relating to the frame available in the purchase confirmation page received from the distributor 102, and may send the cross-sell offer advertisement 304 to the distributor 102, who then displays the same as part 302 of the purchase confirmation page 301 (shown in FIG. 3A). The unique ID, which the distributor had created, may be temporarily stored by SPMS server 105. It can be seen in FIG. 3A, for example, the subscriber/consumer 104 is purchasing a laptop computer, and SPMS server 105 has found the anti-virus software as a matching cross-sell product.

When the subscriber/consumer 104 views the cross-sell offer (in step 5), and if the subscriber/consumer 104 selects the offer, in step 6, the subscriber/consumer 104 is directed to a web store front page of the SPMS. One example of web store front page 306 is shown in FIG. 3B. If the subscriber/consumer 104, in step 7, after viewing the details of the offer from the SPMS web store front page, selects to accept the offer, e.g., in the example of FIG. 3B, by a clicking on the “Checkout” button 307, SPMS server 105 requests from the distributor the billing information for the subscriber/consumer 104 by referencing the unique ID for the subscriber/consumer 104 in step 8. Distributor 102 returns the customer billing information to SPMS in step 9. In steps 10 and 11, SPMS server 105 creates the necessary records for ordering the selected cross-sell product, and uses the same to place a purchase requisition (by the use of a requisition API, which will be described later) with the supplier 101, which may be a different entity than the distributor 102. The supplier after receiving the requisition, creates a new record for the customer, and returns an acknowledgement to the requisition to SPMS server 105 in step 12.

SPMS server 105 then sends the subscriber/consumer 104 information relating to completing the purchase with the supplier 101, for example, an e-mail containing activation information for the newly purchased product in step 13. Using the information received from SPMS server 105, the subscriber/consumer 104 completes the purchase. For example, the subscriber/consumer 104 can use the link contained in the e-mail to the supplier's website where the subscriber/consumer 104 can follow activation instructions (steps 14 and 15). In one embodiment, the subscriber/consumer 104 may be asked, as part of the activation process, to create a log-in ID and a password. Once the new product is activated by the subscriber/consumer 104, in step 17, the supplier 101 notifies SPMS server 105, and when notified, SPMS server 105 starts the subscription management process in step 18, which will be described in more detail later.

According to the embodiment, when the subscriber/consumer 104 logs onto the supplier's website, and chooses to view or change account information relating to the new subscription in step 19, the supplier's website in step 20 redirects the subscriber/consumer 104 to SPMS server 105, and provides the customer ID information to the SPMS server 105, which uses the same to prepare, in step 21, a user interface, e.g., a web page, providing access to the account information relating to the subscriptions/services for the subscriber/consumer 104. In step 22, the subscriber/consumer 104 logs onto the redirected SPMS web interface, and through which the subscriber/consumer 104 can modify, update and/or cancel the subscription in step 23, as will be described in more detail later. In steps 24 and 25, the SPMS server 105 forwards the change the subscriber/consumer 104 may have made during the session along with the customer ID to the distributor 102, who uses the same to update the service accordingly in step 25.

In the above example scenario, while the subscriber/consumer 104 purchased a subscription (an anti-virus software subscription in the example), the customer was not required to provide billing information, e.g., a credit card number, to the supplier. It should be noted that this is true even for a purchase of a tangible product rather than a subscription as was the case in the example. FIG. 3C shows a comparative flow diagram illustrating some of the efficiencies, as compared to a legacy process, that may be realized by the use of the above example scenario. As shown, the embodiment described above may achieve the completion of the cross sale with fewer steps, from the time the subscriber/consumer 104 sees the cross-sell offer or advertisement (“AD”) to the time of the competition of the purchase, that may involve actions by the subscriber/consumer 104, each of which may involve a separate user interface, e.g., separate web pages, and thus may provide improved user convenience and experience.

According to an aspect of the above embodiment, the SPMS 100 may promote supplier products and/or services by dynamically selecting and placing targeted cross-sell offers on the purchase confirmation pages of distributors' websites. Consumers who view and click on these offers may be hyperlinked to the SPMS store (as previously described), where they can conveniently purchase related services without having to reenter billing information.

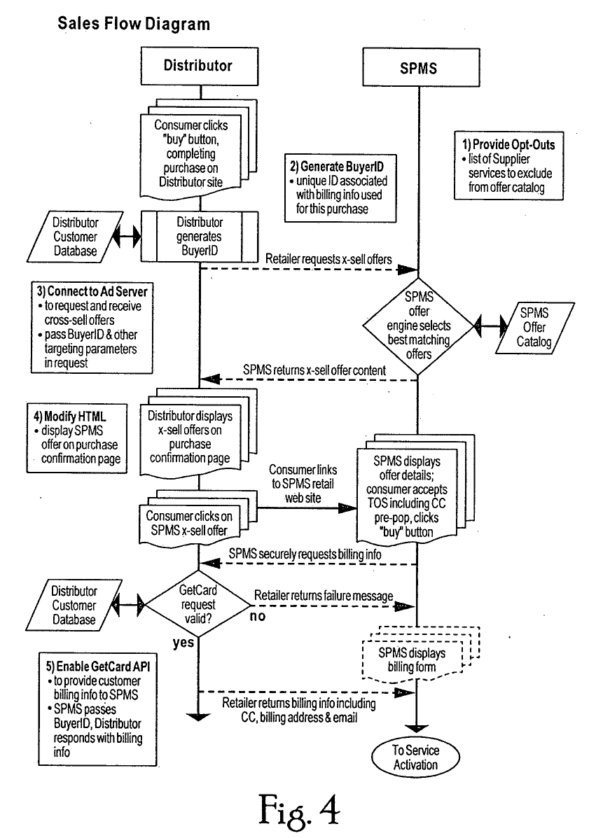

One embodiment of the cross sale process is described in reference to FIG. 4, which illustrates the following procedures, some or all of which may be implemented in providing a cross-sale:

1. The distributor 102 may be given an opportunity to exclude certain products and services from being offered as a cross-sell offer. The exclusion may be noted at the SPMS server 105 as a record.

2. When, as previously described, the subscriber/consumer 104 is completing a purchase on the distributor's website, the distributor 102 may generate a unique BuyerID to reference the billing information used to complete the purchase

3. The distributor 102 may pass a request for cross-sell offer along with the BuyerID, and other parameters used for targeting, to SPMS server 105 as, e.g., URL parameters of a frame to be embedded on the purchase confirmation page. SPMS server 105 may use the targeting parameters to select the best cross-sell offer, which may be returned as HTML or XML; SPMS temporarily stores the BuyerID.

4. The distributor displays the purchase confirmation page including SPMS offer content. Subscriber/consumer 104 who clicks on the SPMS offer may be directed to SPMS's web store (for example one shown in FIG. 3B), where SPMS displays offer details. With, for example, a click of the “Checkout” button, the subscriber/consumer 104 may authorize transfer of billing information from the distributor 102 (if necessary), accept the terms of service (ToS), and complete the purchase. If the subscriber/consumer 104 does not authorize transfer, SPMS server 105 may display one or more web pages to capture the billing information needed to complete the purchase.

5. SPMS server passes the BuyerID and other parameters to the distributor 102 in response to a request for the consumer billing information, for example, using a GetCard API, which will be described in more detail later. The distributor may return the consumer billing information including, e.g., credit card number, billing address and email address to SPMS server 105 via the GetCard API. SPMS server 105 may requisition the supplier to initiate service activation, as will be further described.

To display an SPMS cross-sell offers, the distributor 102 may embed an SPMS frame in the purchase confirmation (or any other) page. An example of an SPMS frame is shown below:

<FRAMESET rows=″width, height″>
<FRAME src=”https://www.TRYandBUY.com/
/promotion/?sessionid=sessionid&sellerid=sellerid&contextSKU=
SKU1%3bSKU2%3bSKU3&buyerid=buyerid&PaymentInstrumentExists=
false&referrerInfo=referrerInfo”/>
</FRAMESET>

The required URL parameters may include “sessionid” (a unique reference to the browser session), “buyerid” (a unique reference to the consumer's billing information) and “referrerID” or “sellerID”, a fixed ID that represents a supplier or a distributor. The “contextSKU” parameter, a unique reference to the purchased product(s), may be omitted, but its inclusion may generate more contextual offers. More than one contextSKU may be included. If more than one SKU is included, multiple instances of this parameter may be sent. Alternatively, an URL-encoded, semicolon-delimited (%3b) list of contextSKU values may be sent. Also, an URL string parameter “PaymentInstrumentExists” may be used to indicate that a payment instrument has been collected for the customer. If none has been provided, SPMS server 105 may collect payment instrument information instead of requesting from the supplier/distributor. This may be an optional parameter, which defaults to ‘true’. ReferrerInfo may be an alphanumeric placeholder for referrer-specific information associated with an order that will be available to referrers.

The frame can be populated in HTML rendered by SPMS server 105. Offers can be selected to maximize Distributor profit, and dynamically targeted by placement. A distributor may provide an opt-out list of suppliers that SPMS will not promote in any of the distributor placements.

If the purchase confirmation page is a secure page, e.g., using the HTTPS protocol, special security provisions may need to be made to allow for multiple domains to co-exist within the one page. This may include configuring an SPMS-hosted URLs in the same secure domain as the confirmation page.

In the SPMS web store front, the subscriber/consumer 104 may authorize SPMS server 105 to, e.g., securely, request the billing information from the distributor 102, including, e.g., credit card, billing address and/or email address. To support the request, while other messaging protocols, e.g., COBRA, GIOP, ICE, DCOM, or the like may be used, in the following illustrative example, the Distributor may implement the SPMS-defined Simple Object Access Protocol (sometimes also referred to as Service Oriented Architecture Protocol) (SOAP) web service interface.

SPMS's request may be made to a secure web service hosted by the distributor. For example, an encrypted HTTPS connection may be used with both client and server certificates installed. The request may also be digitally signed, for additional security. The following is an example of an SPMS request for customer information (For brevity, only the parameter of the SOAP body element is displayed):

```
<CustomerInformationRequest>
    <SessionId>The Distributor sessionid goes here</SessionId>
    <TimeStamp>2001-12-17T09:30:47.0Z</TimeStamp>
    <CustomerId>The Distributor buyerid goes here</CustomerId>
    <ReferrerInfo>The distributor's information sent with as a query
string parameter</ReferrerInfo>
</CustomerInformationRequest>
```

An example successful response to the request may be as follows:

```
<CustomerInformationResponse>
    <PaymentInstrumentInfo>
        <NameOnCard>Joe Customer</NameOnCard>
        <CardNumber>41111111111111111</CardNumber>
        <ExpirationMonth>6</ExpirationMonth>
        <ExpirationYear>2009</ExpirationYear>
        <IsDebit>False</IsDebit>
    </PaymentInstrumentInfo>
    <EmailAddress>Joe.Customer@email.net</EmailAddress>
    <BillingAddress>
        <FirstName>Jane</FirstName>
        <LastName>Doe</LastName>
        <Address1>Apt. 401</Address1>
        <Address2>Nice Street</Address2>
        <City>Anytown</City>
        <StateOrProvince>VA</StateOrProvince>
          <Country>USA</Country>
        <PostalCode>20166</PostalCode>
    <BillingAddress>
</CustomerInformationResponse>
```

Note that in the above examples, all string information may be Extensible Markup Language (XML)-encoded before being sent.

The distributor 102 may preferably positively respond to valid SPMS billing information requests made within certain time period, e.g., 30 minutes, of the subscriber/consumer's original purchase on the distributor web site. This can allow the subscriber/consumer 104 time to download or install their original purchase, and consider the SPMS offer before approving the transfer of billing information to SPMS server 105.

In an embodiment, the distributor's terms of service and privacy policy may be made to allow the transfer of user data (including billing information) to SPMS server 105 for the purchase of third party services.

Cross-sales in the SPMS web store are processed by SPMS's ecommerce platform and payment gateway, which may collect billing information from the distributor and requisition the service from the supplier before confirming the sale to the subscriber/consumer 104. SPMS server 105 may then send an email confirmation to the subscriber/consumer 104, including a link to the supplier website where the service can be activated. The subscriber/consumer 104 may visit the supplier site to a) complete a modified registration which includes account set-up (with log-in user name and password creation, but collection of billing information may not be necessary), b) download the application (if needed), and/or c) install and activate the application or log into the web service, as needed. The supplier then may notify SPMS server 105 of the activation, so that SPMS server may begin the subscription lifecycle, and to charge the credit card of subscriber/consumer 104, as needed.

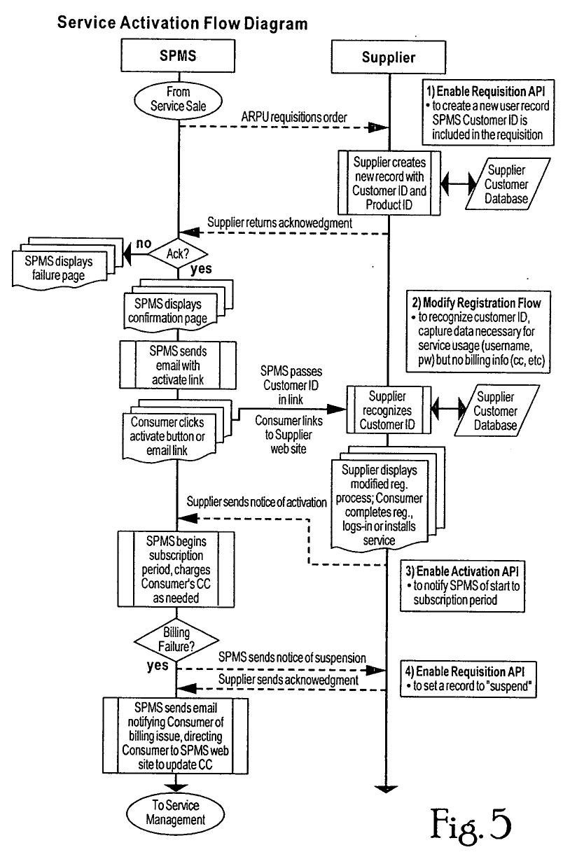

One embodiment of a product/service activation process is described in reference to FIG. 5, which illustrates the following procedures, some or all of which may be used to implement the product/service activation process:

1. While the consumer awaits purchase confirmation in the SPMS web store, SPMS server 105 may initiate an order with the supplier 101 by passing an SPMS customer ID, supplier product ID, a subscription ID, and/or subscriber email address with the use of the Requisition API, which will be described in more detail later. The supplier 101 may create a new user record, and then may return a positive acknowledgement so SPMS server 105 may display a purchase confirmation page directing the consumer to supplier's email for service activation instructions. SPMS server 105 may send an email to the subscriber/consumer 104 with a link to the supplier's web site where the service may be activated. The activation link in the email may contain credentials (e.g., Customer ID, subscriber email, SKU or the like) that the supplier may use to match to the new user record. The subscriber/consumer 104 may link to the supplier's site, where the credentials may identify him as a paid SPMS subscriber so the supplier can present a modified registration flow, allowing the consumer to set up new credentials and establish an account, without having to enter billing information.

2. The subscriber/consumer 104 may complete the registration, and then may download and/or install the application (as needed) or logs into the web service. The supplier 101 may optionally call SPMS's Activation API to notify SPMS that the customer is actively using the service.

3. SPMS server 105 begins the subscription lifecycle, charging the subscriber/consumer's credit card, e.g., monthly, according to the subscriber/customer's SPMS billing cycle.

4. In the event there may be a billing problem, SPMS server 105 may use the Requisition API to instruct the supplier 101 to change account status to “suspend”, and may send an email directing the subscriber/consumer 104 to the SPMS web store to provide updated billing information.

In order to merchandise and promote the services in a fashion consistent with the supplier's brand and HTML guidelines, SPMS server 105 may require the following to be supplied by the supplier 101:
a. Brand marks, logos, and product images
   i. Images
   ii. Use guidelines
b. Web/HTML style sheets
   i. Colors
   ii. Graphic treatments e.g. shading, gradations, etc
c. Product/service descriptions
   i. Short (e.g. 15 words limit) description (sell copy)
   ii. Detail description (no word limit)
      1. Full product description
      2. Frequently asked questions
      3. System requirements
d. Distributor opt-out list

For each sale made in the SPMS store, SPMS may requisition the supplier, e.g., by passing an SPMS-created globally unique customer ID (to identify the subscriber/consumer 104 as an SPMS customer), a supplier-provided Product ID (to identify the purchased product) and an SPMS-created account number (referencing the subscription). The customer ID may be, e.g., a 128-bit identifier that must be stored in the supplier's database. The requisition may be made via SPMS's supplier interface, which will be described in more detail later.

The supplier 101 may use these parameters to set-up a new customer record, and to respond with an acknowledgment, preferably, in real time. When the item purchased is a service, e.g., a web messaging service, after a product has been successfully requisitioned, SPMS server 105 may send an email to the subscriber/consumer 104 containing a hyperlink to an account registration page on the supplier's website. This hyperlink may contain the same customer ID, Product ID, account number, and the consumer's email address, e.g., in the following example format the values for the parameters of which may be URL encoded:

https://SUPPLIER.com/REGISTRATION?AN=accountnumber&EA=
emailAddress&LUID=arpuID&CQU=sku

The supplier 101 may use the URL parameters to match the registering subscriber/consumer 104 to a customer record established with the sales requisition. The suppler 101 may be required to create a modified registration flow to accommodate a new SPMS customer. The modified registration will capture only fields necessary to provision the product to the customer (i.e. user name, password, service preferences etc.), while eliminating any fields designed to capture billing information from the customer. Also, any up-selling in the registration path should point back to the SPMS store.

According to an embodiment, the subscriber/consumer 104 may maintain two sets of credentials: one username/password pair for the supplier's site, where they may manage the usage features of their service, and another set of credentials for the SPMS web store, where they may manage billing and subscription term and tier. When the consumer logs onto the supplier's site, the supplier 101 may recognize the subscriber/consumer 104 as an SPMS-sourced customer and present a modified site providing typical access to service usage features and support, but with access to a) billing pages, b) subscription cancellation pages and/or c) upgrade or downgrade to different subscription tiers replaced with appropriate links to the SPMS web store. At the SPMS store, the subscriber/consumer 104 may log on to revise, e.g., the billing information, cancel their service, change their subscription tier, or access related support.

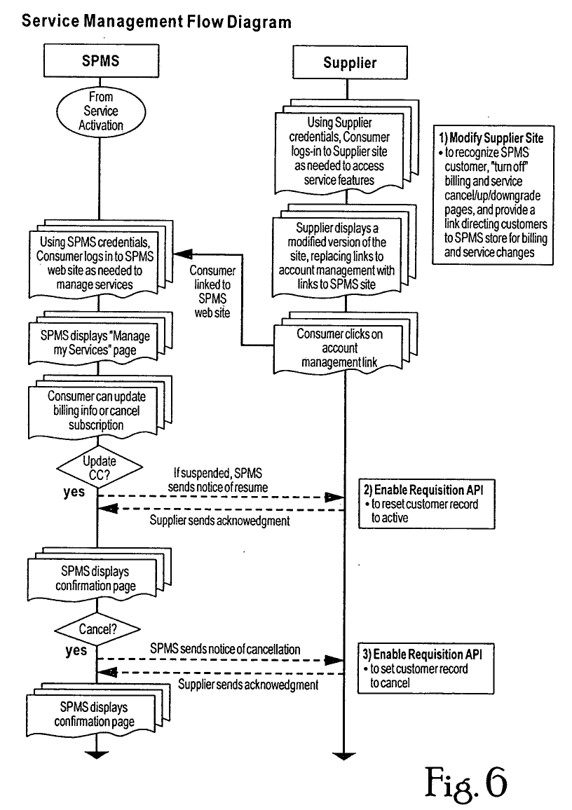

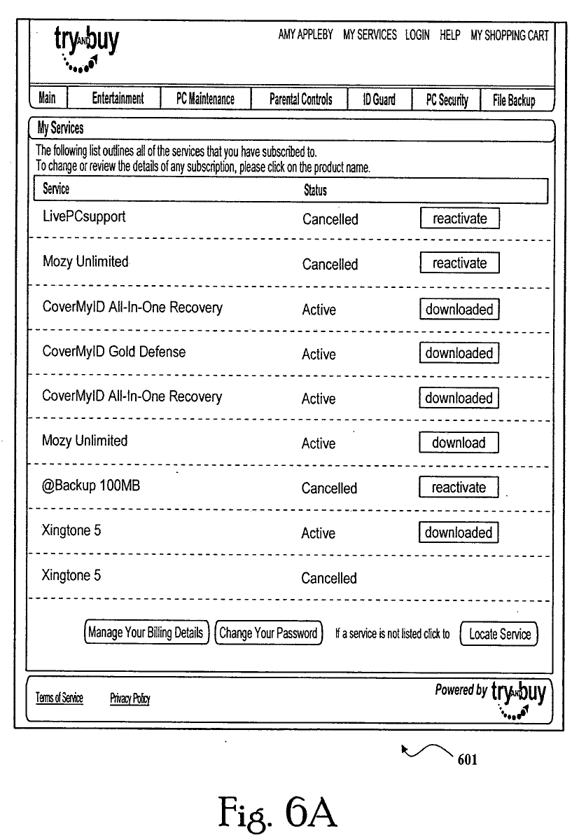

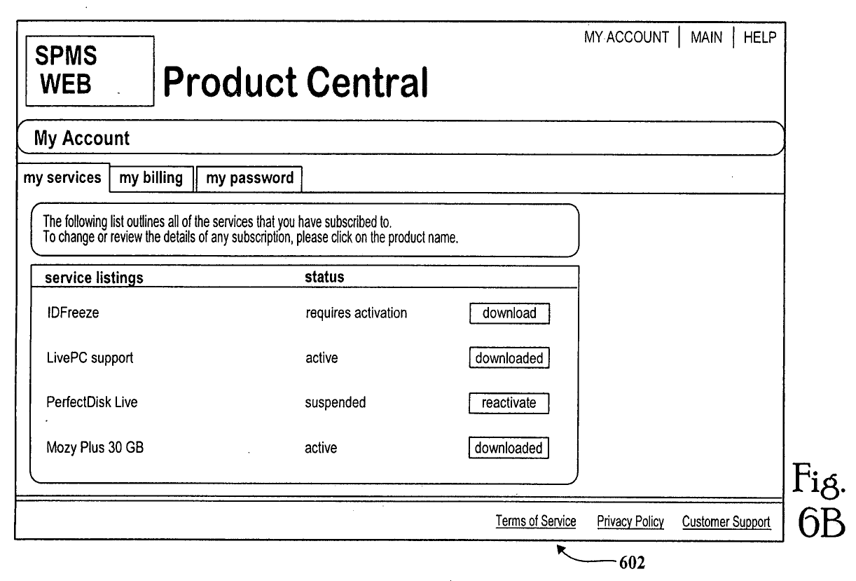

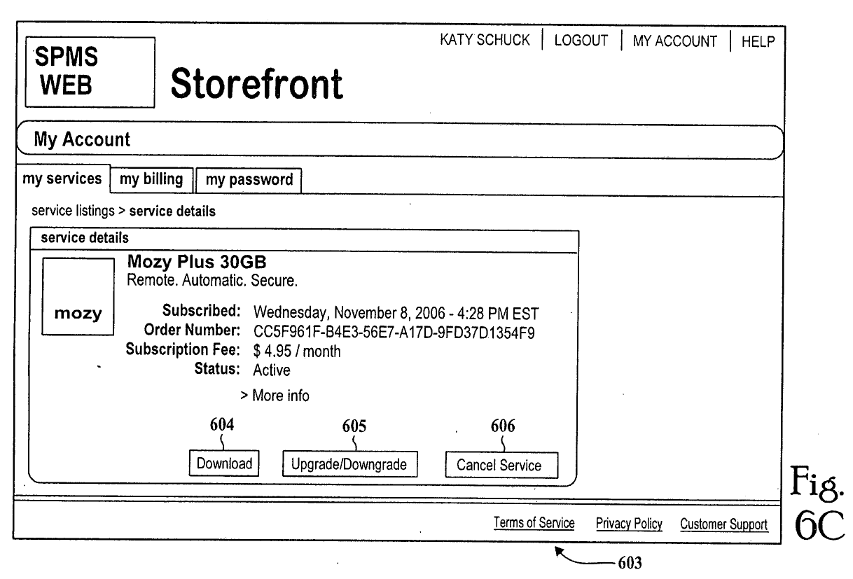

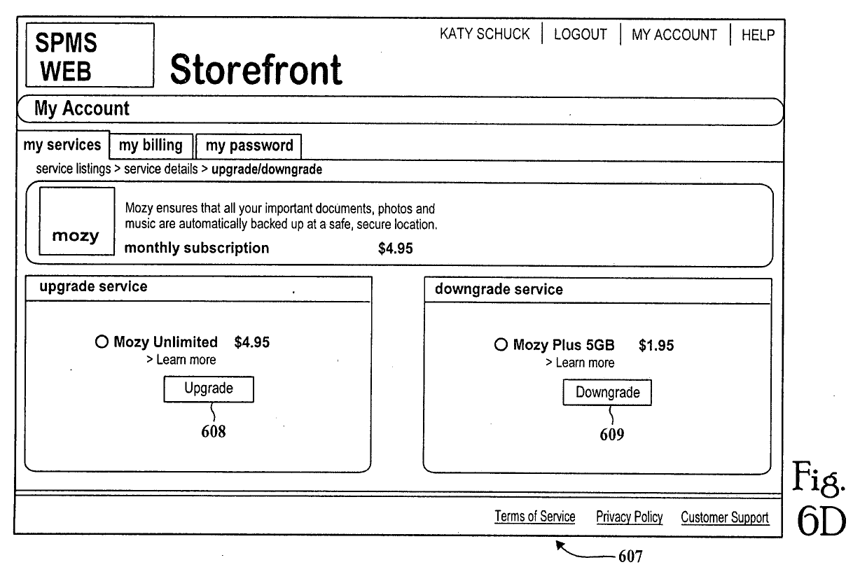

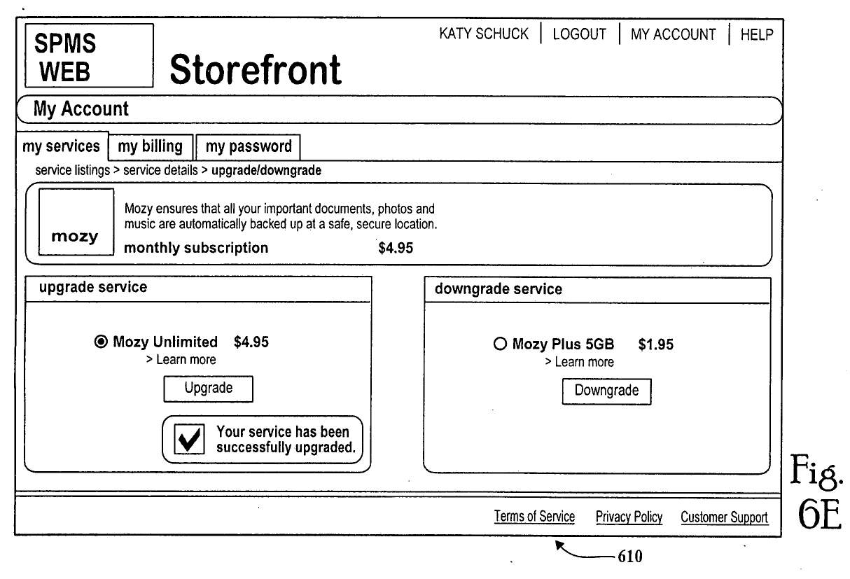

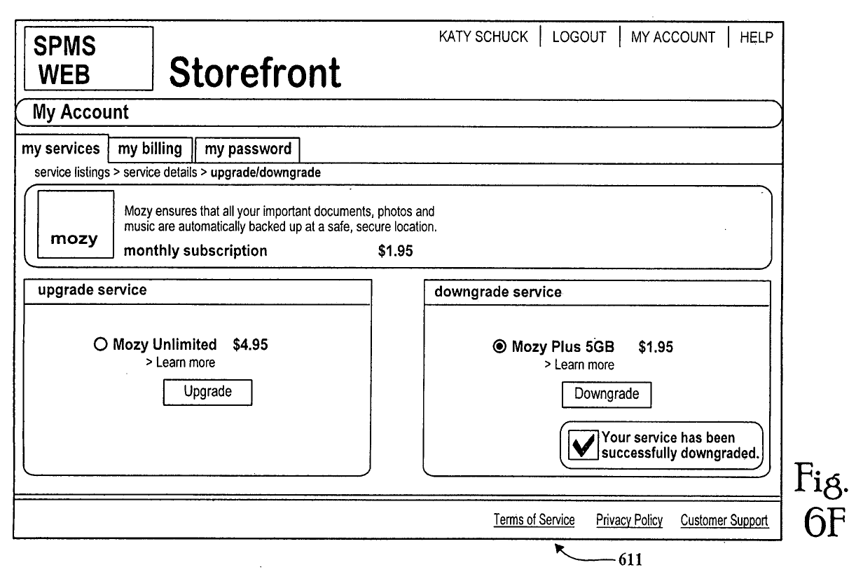

One embodiment of an account management process is described in reference to FIG. 6, which illustrates the following procedures, some or all of which may be performed to variously implement the account management process:

1. When the subscriber/consumer 104 logs onto the supplier website using the supplier's credentials, the supplier 101 may provide a modified site experience, directing the subscriber/consumer 104 to the SPMS store for billing and subscription management.

2. A subscriber/consumer 104 may log onto the SPMS web store using SPMS credentials. From the SPMS store, the consumer may update the billing information. If a service had been suspended due to a billing problem, once proper billing information is re-supplied, SPMS server 105 may use the Requisition API to notify the supplier that the account status has been changed to active.

3. Also from the SPMS store, the subscriber/consumer 104 may cancel the subscription. SPMS server 105 may use the Requisition API to notify the supplier to set the account status to ‘suspended,’ and then to ‘cancelled’, e.g., after a 30 day period within which the consumer may choose to reactivate the subscription. From the SPMS store, the consumer may also change subscription tiers (for example, from 100 mb backup storage space to 200 mb storage). SPMS server 105 may use the Requisition API to notify the Supplier of the subscription changes.

The supplier interface may include the Requisition API, which may allow SPMS server 105 to notify the supplier 101 when a subscriber/consumer 104 orders, upgrades, downgrades, or cancels a product. The supplier interface may also be used to suspend a product, giving customers who are delinquent in payment the opportunity to correct credit card issues.

A supplier 101 may develop codes to work with the supplier interface as outlined in the detailed Supplier Interface description that appears later in this specification. The supplier 101 may also recognize and verify the SPMS's SSL client certificate. The supplier 101 may also configure a service-side SSL certificate.

To allow a centralized management of subscription accounts by the SPMS server 105, a supplier 101 may modify the supplier web site/service user interface for SPMS customers to direct the subscriber/consumer 104 (e.g., by providing a link) to the proper SPMS store, e.g., for the following types of subscription management options. The user interfaces 601 and 602 shown in FIGS. 6A and 6B are examples of such SPMS store, from which a subscriber/consumer 104 may select one or more subscription accounts to manage.

1) Billing Management: A supplier 101 may modify the supplier website/service user interface (“UI”) for SPMS customers to not provide access to billing management areas, and instead replace the same with link(s) to the SPMS web site, so that customers may be directed to the proper SPMS store to update billing information. In addition, the supplier 101 may enable the elements of the Supplier Interface necessary to process service suspension and reactivation instructions from SPMS server 105.

2. Service Cancellation: A supplier 101 may modify the supplier website/service UI for SPMS customers to not provide access to service cancellation option, and instead replace them with link(s) to the SPMS website, so that subscriber/consumer 104 may be directed to the proper SPMS store to cancel their subscription. In addition, the supplier 101 may enable the elements of the Supplier Interface necessary to process service cancellation instructions from SPMS server 105.

3. Change in Subscription Tier (up or down sells): A supplier 101 may modify the supplier website/service UI for SPMS customers to not provide access to service up-sell or down-sell options, and instead may replace them with link(s) to the SPMS website, so that subscriber/consumers 104 may be directed to the proper SPMS store to change their subscription tier. In addition, the supplier 101 may list any up or down-sell subscription tiers as unique SKUs in the SPMS store, and enable the elements of the Supplier Interface necessary to process upgrade/downgrade instructions from SPMS server 105. FIGS. 6C through 6F illustrate an example of a subscription management options available to a subscriber/consumer 104 from the SPMS website. In particular, when the subscriber/consumer 104 selects a particular subscription from a main subscription management page (e.g., the web page UI 602 shown in FIG. 6B), SPMS server 105 may provide a service information page 603, e.g., shown in FIG. 6C, which in this example, includes the options for downloading 604 related material or software, for upgrading 605 to a higher tier or to download to a lower tier of service, and to cancel 606 the subscription. When the subscriber/consumer 104 selects the upgrade/downgrade option, SPMS server 105 may present the subscriber/consumer 104 with the upgrade/downgrade page 607, e.g., as shown in FIG. 6D, from which the subscriber/consumer 104 may choose to upgrade 608 (e.g., in the example, from the current storage capacity of 30 GB to unlimited capacity), in which case, SPMS server 105 may display the upgrade confirmation page 610 (e.g., shown in FIG. 6E), or to downgrade 609 (e.g., in the example, from the current storage capacity of 30 GB to 5 GB of storage capacity), in which case, SPMS server 105 may display the downgrade confirmation page 611, e.g., shown in FIG. 6F.

SPMS server 105 may additionally allow management of expiration/renewal of a subscription. If the subscription is for a finite duration of time, SPMS server 105 may monitor or track the expiration of the subscription, and for example, send expiration warning e-mail to the subscriber/consumer 104, and/or, as another example, may automatically renew the subscription for another subscription term if the subscriber/consumer 104 had opted for an automatic renewal.

SPMS's infrastructure may be based on a three-tiered architecture, comprised of a UI layer, represented by the web storefront, a web services tier for reliability and scalability, and a database tier for accurate reporting and data reproducibility.

The UI layer may be hosted with server computers, e.g., Apache/Tomcat servers on, e.g., a RedHat Linux platform. The UI may be designed to be highly customizable by, e.g., applying XSLT transforms. Sessions in the Web Tier may be maintained across several servers for redundancy.

The web services tier may be built on a server operating platform, e.g., the Microsoft Windows 2003 Server platform. All web services may be developed as Service-Oriented Architecture components, and can provide direct access to the suppliers 101 and distributors 102. Each web services component may be designed to be redundant and stateless, which may greatly increase the reliability.

The SPMS data tier may utilize, e.g., MySql on Linux, e.g., configured as 2-way redundant servers. To provide scalability, additional databases may be horizontally partitioned as 2-way redundant servers, with each pair handling a fraction of the capacity. All data may be securely backed up on magnetic tape for reproducibility.

According to an embodiment, and preferably, SPMS 100 utilizes existing standards. All interfaces to the suppliers and distributors may be implemented as, e.g., SOAP/XML interfaces as defined by WSDLs and XML schemas. Some interfaces may be further defined by the de facto business standard produced by, e.g., Commerce One, xCBL 4.0. Commerce One's Common Business Language (xCBL) has been adopted by Oasis, and is being incorporated into Universal Business Language (UBL). The XCBL documentation can be found from the website, http://www.xcbl.org.

Security: Below are some of the measures that may be taken to ensure consumer security:
There may be three monitored network security zones, which may be configured with redundant firewalls.
Each security layer can be made to only have access to information that applies to that particular level. For example, credit card information can be made inaccessible to the user interface layer. For example, the presentation layer may only request the last four digits of a credit card.
Sensitive consumer payment information may be stored in the database encrypted.
Database encryption keys can be managed in a repository separate from the code. Access to this repository can be limited to those personnel who are the VP level and above.
Interfaces that pass sensitive information may employ channel security, as well as application level security.
The SPMS store can be provided with the ability to digitally sign URL requests when consumers are redirected for additional authentication.
Database passwords used by applications may be stored encrypted.
All applications and libraries running in SPMS web services tier can be digitally signed using private keys stored in separate repositories.
Encryption/decryption libraries may be stored in a repository separate from the rest of the code. These libraries may enforce code-level security policies.
Security violations including unauthorized access attempts, invalid signatures, or malformed requests may trigger alerts.
Client and server SSL certificates may be required on all interfaces to the suppliers 101 and distributors 102.

Scalability: SPMS's infrastructure may be configured to support, e.g., 35 transactions per second, but can scale to higher (e.g., 200 transactions per second) with additional hardware and database configuration. The hardware may be configured as, e.g., two pipelined 3 tier deployments. The system may also be designed such that a single pipeline will handle the entire production load in the event of a failure in any tier of the other pipeline. The database may be configured as a two-way redundant database server, based on, e.g., MySQL's server 2-way clustering capability. The web tier and web services tier may be made to allow to scale nearly linearly as necessary by adding hardware. This configuration may be limited by the number of transactions per second that a single instance of the database can handle. Additional scaling may be achieved in the data tier by partitioning the tables across multiple physical databases and installing more database hardware. The SPMS architecture may also be a fully, horizontally partitioned system with transactions routed to the appropriate pipeline and may be linearly scalable.

Reliability: SPMS's web tier may maintain sessions across servers using, e.g., Tomcat session replication clustering. Intelligent load balancers can detect pipeline failures and failover to the available servers. The web services tier applications may be made stateless, redundant and fault tolerant. The SPMS data tier may be configured as a redundant 2-way MySQL cluster with a RAID-5 configuration. Incremental data may be remotely backed-up daily and fully archived weekly. The system may be designed such that no single point of failure will result in a system failure. This may extend to everything from power supplies to routers or switches. All software may also be designed to recover from component failures by re-directing traffic to active standbys. When transaction traffic warrants, site redundancy may also be employed.

### Supplier/Distributor System Requirements

To implement SPMS's Requisition API, the suppliers 101 and/or distributors 102 may acquire the ability to deploy a web service application. Any platform that accepts and parses SOAP messages (or any other messaging protocol used by SPMS) may be able to accept the SPMS requisition messages. If the partner has a .NET environment, additional stub code can be provided.

### Distributor Interface

The distributor integration web service is described in greater detail in the Appendix hereto. In one embodiment, the only interface the distributor 102 may be required to implement may be the “requestCustomerInfo” operation, which SPMS server 105 may call to request customer information.

The following Table I describes the parameters that SPMS server 105 may send with a customer information request. The full description of the interface is defined in more detail later.

TABLE I
Request parameters

| Customer Information | |
|---|---|
| Request Parameter | Description |
| Session ID | An optional parameter that the Distributor |
| | may pass to SPMS as an URL parameter |
| | and which SPMS will pass back to the |
| | Distributor to collect customer information |
| | related to a session. |
| Timestamp | This is a timestamp of the request, which |
| | may optionally be used in conjunction with |
| | a digital signature to verify the authenticity |
| | of the requestor. |
| CustomerId | This parameter correlates to the buyer ID |
| | passed as an URL parameter. This value |
| | represents a unique ID which the |
| | Distributor uses to identify an individual |
| | customer. |
| Signature | In addition to client and server certificates |
| | to secure the communication channel |
| | between SPMS and the Distributor, the |
| | Distributor may additionally choose to |
| | verify the authenticity of the request by |
| | validating a digital signature. This |
| | parameter is optionally included in the |
| | request. |

The following Table II describes the parameters that distributor 102 may send with a response to the customer information request.

TABLE II
Response parameters:

| Customer Information | |
|---|---|
| Response Parameter | Description |
| Name on Card | The name of the consumer as it appears on |
| | the credit card. |
| Card Number | The number of the credit card. |
| Expiration Month | The month the card will expire. |
| Expiration Year | The Year in which the card will expire. |
| Security Code | An optional parameter that represents the |
| | security code on the consumer's credit |
| | card. |
| Email Address | The email address of the customer. |
| Billing Address - First Name | The first name as it appears on the |
| | consumer's billing address. |
| Billing Address - Last Name | The last name as it appears on the |
| | consumer's billing address. |
| Billing Address - Address 1 | The first line of the consumer's billing |
| | address. |
| Billing Address - Address 2 | The second line of the consumer's billing |
| | address. |
| Billing Address - City | The city in which the consumer resides. |
| Billing Address - State | The state or province in which the |
| or Province | consumer resides. |
| Billing Address - Country | The country in which the consumer |
| | resides. |
| Billing Address - Postal Code | The postal district in which the consumer |
| | resides. |

The following Table III describes the parameters that distributor 102 may send with a negative response to the customer information request.

TABLE III
Negative response parameters:

| Error Code Type | Description |
|---|---|
| Fatal | The request as it has been constructed will |
| | not result in a positive response. This may |
| | be due to an invalid account request or an |
| | authentication failure. An accompanying |
| | error description is optional. |
| Transient | The request has failed because of an |
| | intermittent problem with the Distributor's |
| | sysem, possibly due to a service's |
| | temporary unavailability. SPMS may retry |
| | the same request for a configurable number |
| | of times or until the request succeeds. |
| Unknown | This error condition represents an |
| | exceptional case that may be due to a |
| | development code error. |

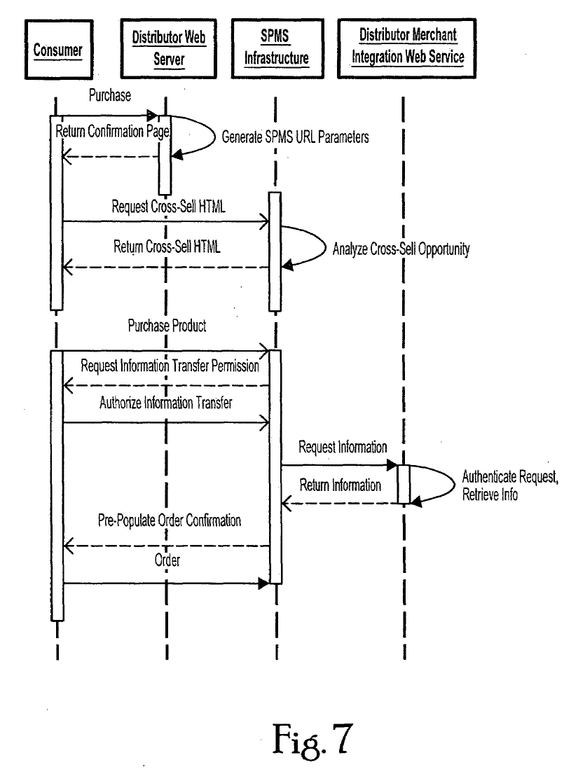

An example of use-case scenario is shown in FIG. 7, and is described below: As shown in FIG. 7, the subscriber/consumer 104, after purchasing a product may be directed to the distributor's purchase confirmation page.

The distributor 102 may generate the purchase confirmation page, and may embed a frameset with an SPMS URL containing parameters that SPMS may parse. The confirmation page may be rendered in the subscriber/consumer's browser. The SPMS frame can be populated with a cross-sell promotion.

The subscriber/consumer 104 may elect to purchase the presented cross-sell offer. SPMS server 105 requests the subscriber/consumer's consent to pull customer information from the distributor 102. The consumer gives consent and the information is securely requested from the distributor. The order is processed.

### Error Handling

In the event that a request cannot be successfully processed, three negative responses may be returned. As shown in Table IV below, the three supported failure conditions may be Fatal, Transient, and Unknown.

TABLE IV
Error Conditions

| Error Condition | Description |
|---|---|
| Fatal | The message was received correctly, but |
| | the message cannot result in a positive |
| | response. This may be due to an invalid |
| | account, session or invalid security |
| | credentials. |
| Transient | An intermittent problem was encountered |
| | in the distributor's system. A retry may be |
| | warranted. |
| Unknown | An exceptional error occurred while |
| | processing the request. This may indicate a |
| | development coding error. |

If a fatal error occurs, SPMS server 105 may not retry the request, because it may be assumed that the request may never succeed as-is. A transient error response may indicate to SPMS server 105 that the system is temporarily unavailable. SPMS server 105 may retry, e.g., a configurable number of times, over, e.g., a configurable period of time before rejecting the order. An error code of “Unknown” may be returned to indicate a possible application coding error.

A negative response due to a transient system problem may be of the form:

```
<CustomerInformationResponse>
  <ErrorInfo>
  <ErrorCode>Transient</ErrorCode>
  <ErrorText>System unavailable.</ErrorText>
  </ErrorInfo>
</CustomerInformationResponse>
```

A negative response indicating that the request was processed as a fatal error may take the following form. This error may be generated to indicate that the message is invalid and a retry is unwarranted:

```
<CustomerInformationResponse>
    <ErrorInfo>
        <ErrorCode>ProcessFatal</ErrorCode></ErrorCode>
        <ErrorText>Account Not found.</ErrorText>
    </ErrorInfo>
</CustomerInformationResponse>
```

A negative response indicating a potential software coding error may take the following form:

```
<CustomerInformationResponse>
  <ErrorInfo>
  <ErrorCode>Unknown</ErrorCode></ErrorCode>
  <ErrorText><ErrorText>
  </ErrorInfo>
</CustomerInformationResponse>
```

### Supplier Interface

A supplier's development effort may typically involve three tasks: 1) implementing the requisition web service; 2) accepting SPMS customer information within the distributor's registration landing page; and 3) restricting or modifying UI elements from the supplier website that do not apply to SPMS customers. The latter may include customer billing information pages, service upgrade/downgrade pages, or certain billing help pages.

Integrating with the Requisition Interface

SPMS's service requisition may be a SOAP-based request defined by Commerce One's de facto business interface standard, XCBL. This standard has been adopted by the OASIS standards group and is being incorporated into the Universal Business Language. There may be different ways to implement the interface to allow SPMS server 105 to notify the supplier 101 when the subscriber/consumer 104 orders, upgrades, downgrades, or cancels a service. The requisition interface can also be used to suspend a service, giving customers delinquent in payment the opportunity to correct credit card issues.

The XCBL standard is both broad and deep with regard to general cases. SPMS server 105 may streamline the interface by, e.g., sending only essential information required to fulfill a service request while still satisfying the standard.

### Interface Description

The following is a description of an example embodiment of the message sent by SPMS server 105 to the supplier 101 to requisition the order. In this example, the message is implemented according to the XCBL standard, which is created by Commerce One, and the definition of which standard could be found at http://www.xcbl.org/xcbl40/xcbl40.html. SPMS server 105 may send a requisition for different purposes indicated by the “PurposeCode.” SPMS server 105 may send the following requisition codes for the reasons listed in Table V below:

TABLE V
Requisition Codes

| PURPOSE CODE | DESCRIPTION |
|---|---|
| Original | A request for provisioning a new account. |
| Suspend | Sent to indicate the user should not have |
| | access to the service, but his record should |
| | not yet be erased. This condition may arise |
| | for blocked accounts, or when the user is |
| | granted a grace period in which to re- |
| | establish his account. |
| Cancel | Sent to indicate the users account is |
| | terminated as the result of user action or |
| | non-payment. |
| Replace | Sent to indicate an atomic subscription |
| | change, requested in order to avoid deleting |
| | and re-creating the account if the user |
| | merely changing service tiers. |
| Change | Sent to indicate attributes of the account |
| | have been changed by the Distributor. Not |
| | required. |
| Reactivate | Sent to indicate when an account in the |
| | suspended state has been reactivated by the |
| | user. |

These configurations may represent different capabilities and may be determined by the distributor 102. Based on configuration rules one or more of the different requisition type values shown below in Table VI may be sent:

TABLE VI
Requisition Types

| RequisitionType | Description |
|---|---|
| OrderRequest | A request to provision the order. |
| Validate | A request to validate the order before |
| | creating a record. (Optional) |
| Commit | Commit an OrderRequest. (Optional) |
| Rollback | Rollback an OrderRequest. (Optional) |

In one embodiment, an OrderRequest requisition may be all that is necessary. In another embodiment, a Validate, OrderRequest, and Commit requisition may also be sent, which may guarantee synchronized state between SPMS server 105 and the distributor 102.

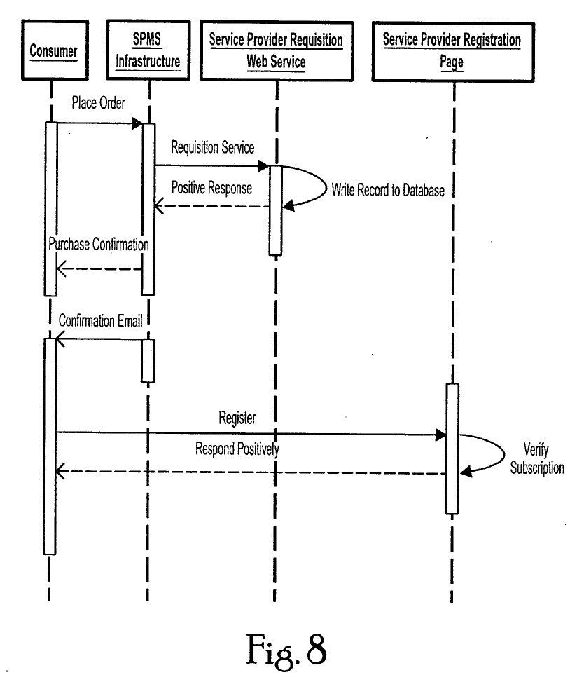

An example of a new order requisition scenario is described below, and in reference to FIG. 8. As shown in FIG. 8, The subscriber/consumer 104 may place an order with SPMS's storefront. The SPMS server 105 may requisition the service from the supplier 101. The supplier 101 may write an incomplete record to the database. The subscriber/consumer 104 may be sent an email confirmation containing a supplier registration link. The subscriber/consumer 104 may visit the supplier's registration page, which may gather from subscriber/consumer 104 supplier specific information. The subscription may be verified using data sent along with the registration page as HTTP GET parameters and checking these values against the database, which may have been previously populated after receiving the requisition message.

An example of an OrderRequest (Original) is provided below with four different responses: one positive acknowledgment and three different error responses. The response to a requisition may be, e.g., an ApplicationResponseType as specified by XCBL 4.0.

The following is an example of an “Original, Order Request” requisition:

```
<Requisition>
  <RequisitionHeader>
  <RequisitionNumber>
    <ReqNumber>C7C94860-0EFF-4226-AF7E-
    3EB708936527</ReqNumber>
  </RequisitionNumber>
  <RequisitionIssueDate>2005-05-
  02T13:20:00-05:00</RequisitionIssueDate>
  <RequisitionType>
    <RequisitionTypeCoded>
    OrderRequest</RequisitionTypeCoded>
  </RequisitionType>
  <Purpose>
    <PurposeCoded>Original</PurposeCoded>
  </Purpose>
  <RequisitionCurrency>
    <CurrencyCoded>USD</CurrencyCoded>
  </RequisitionCurrency>
  <RequisitionLanguage>
    <LanguageCoded>en</LanguageCoded>
  </RequisitionLanguage>
  <RequisitionParty>
    <RequisitionerParty>
    <PartyID>
      <Ident>SPMS, Inc.</Ident>
    </PartyID>
    </RequisitionerParty>
    <BuyerParty>
    <PartyID>
      <Agency>
      <AgencyCoded>Other</AgencyCoded>
      <AgencyCodedOther>ArpuIdentityService</AgencyCodedOther>
      <AgencyDescription/>
      </Agency>
      <Ident>6F2AC5DE-65D6-484c-A338-7175C115407A</Ident>
    </PartyID>
    </BuyerParty>
  </RequisitionParty>
  <RequisitionPaymentInstructions>
    <PaymentMethod>
    <PaymentMeanCoded>CreditCard</PaymentMeanCoded>
    <!-- Credit card, or debit cards are acceptable. -->
    <CardInfo>
      <CardNum />
      <CardRefNum>3DAA38DE-61D2-494c-B342-
7183A115408B</CardRefNum>
      </CardInfo>
    </PaymentMethod>
    </RequisitionPaymentInstructions>
  </RequisitionHeader>
  <RequisitionDetail>
    <ListOfRequisitionItemDetail>
    <RequisitionItemDetail>
      <RequisitionBaseItemDetail>
      <LineItemNum>
        <BuyerLineItemNum>1</BuyerLineItemNum>
        <!-- A cardinal number within this requisition.. -->
      </LineItemNum>
      <ItemIdentifiers>
        <PartNumbers>
        <StandardPartNumber>
<ProductIdentifierQualifierCoded>StockNumber-
</ProductIdentifierQualifierCoded>
          <ProductIdentifier>314159</ProductIdentifier>
        </StandardPartNumber>
        </PartNumbers>
      </ItemIdentifiers>
      <TotalQuantity>
        <QuantityValue>1</QuantityValue>
        <UnitOfMeasurement>
        <UOMCoded>Other</UOMCoded>
        <UOMCodedOther>UnlimitedAccess</UOMCodedOther>
        </UnitOfMeasurement>
      </TotalQuantity>
      <BaseItemReferences>
        <ListOfItemReferences>
        <ReferenceCoded>
          <ReferenceTypeCoded>AccountNumber-
          </ReferenceTypeCoded>
          <PrimaryReference>
          <RefNum>6043EE8D-CBB6-4bae-AF1C-
          8F7A9DCB1849</RefNum>
          </PrimaryReference>
        </ReferenceCoded>
        <ReferenceCoded>
          <ReferenceTypeCoded>OriginalPurchaseOrder-
          </ReferenceTypeCoded>
          <!-- The original order number is referenced. -->
          <!-- used by SPMS SS and PM only -->
          <PrimaryReference>
          <RefNum>5897BE61-2C67-459d-8906-
          F250992F08CC</RefNum>
          </PrimaryReference>
          <SupportingReference>
          <RefNum>1</RefNum>
          <!-- The LineItemNum in the original order request. -->
          </SupportingReference>
        </ReferenceCoded>
        <ReferenceCoded>
          <ReferenceTypeCoded>OfferNumber</ReferenceTypeCoded>
          <!-- used by SPMS SS and PM only -->
          <PrimaryReference>
          <RefNum>1</RefNum>
          <!-- This offer that this product belongs to. -->
          </PrimaryReference>
        </ReferenceCoded>
        <ReferenceCoded>
          <ReferenceTypeCoded>OfferGroup</ReferenceTypeCoded>
          <!-- used by SPMS SS and PM only -->
          <PrimaryReference>
          <RefNum>5</RefNum>
          <!-- This bundled offer that this product belongs to. -->
          </PrimaryReference>
        </ReferenceCoded>
        </ListOfItemReferences>
      </BaseItemReferences>
      </RequisitionBaseItemDetail>
      </RequisitionItemDetail>
    </ListOfRequisitionItemDetail>
  </RequisitionDetail>
</Requisition>
```

### Positive Requisition Response

An example of a positive requisition response may be:

```
  <ApplicationResponse>
  <ApplicationResponseHeader>
  <ApplicationResponseIssueDate>2005-05-02T13:20:00-
05:01</ApplicationResponseIssueDate>
<ApplicationResponseTypeCoded>AcknowledgeProcess-
</ApplicationResponseTypeCoded>
  <ApplicationResponseSender>
    <core:PartyID>
    <core:Ident>Distributor “A”</core:Ident>
    </core:PartyID><core:ListOfIdentifier>
    <core:Identifier>
      <core:Ident>21237</core:Ident>
    </core:Identifier>
    </core:ListOfIdentifier>
  </ApplicationResponseSender>
  <ApplicationResponseReceiver>
    <core:PartyID>
    <core:Ident>SPMS, Inc.</core:Ident>
    </core:PartyID>
  </ApplicationResponseReceiver>
  <BusinessDocumentTypeCoded>Requisition-
  </BusinessDocumentTypeCoded>
  <DocumentReference>
    <core:RefNum>234879234</core:RefNum>
  </DocumentReference>
  <DocumentStatusCoded>ProcessedOK</DocumentStatusCoded>
  </ApplicationResponseHeader>
</ApplicationResponse>
```

### Error Handling

The three error conditions as defined in Table VII below may be handled, as returned in the document status field and the error type code fields

TABLE VII
Error Conditions

| Error Condition | Description |
|---|---|
| ProcessFatalError | The message was correctly received but |
| (PayloadError) | cannot be successfully acknowledged due |
| | to invalid information contained within the |
| | request. |
| FatalError (BusyError) | There is an intermittent problem in the |
| | system. A retry may be warranted. |
| FatalError (Unknown) | The message was not fully processed and |
| | the application cannot continue due to an |
| | error of unknown origin. This is a |
| | potential indication of a development |
| | coding error. |

An example of an error response given the condition that the information contained in the requisition will not result in a positive response and therefore, there is no need for SPMS to retry. In this example, the document status code is “ProcessFatalError” and the error type code is “PayloadError”:

```
<ApplicationResponse >
  <ApplicationResponseHeader>
  <ApplicationResponseIssueDate>2005-05-02T13:20:00-
05:01</ApplicationResponseIssueDate>
  <ApplicationResponseTypeCoded>Error-
  </ApplicationResponseTypeCoded>
  <ApplicationResponseSender>
    <core:PartyID>
    <core:Ident>Company “A”</core:Ident>
    </core:PartyID><core:ListOfIdentifier>
    <core:Identifier>
      <core:Ident>234985340834</core:Ident>
    </core:Identifier>
    </core:ListOfIdentifier>
  </ApplicationResponseSender>
  <ApplicationResponseReceiver>
    <core:PartyID>
    <core:Ident>SPMS, Inc.</core:Ident>
    </core:PartyID>
  </ApplicationResponseReceiver>
  <BusinessDocumentTypeCoded>Requisition-
  </BusinessDocumentTypeCoded>
  <DocumentReference>
    <core:RefNum>234879234</core:RefNum>
  </DocumentReference>
  <DocumentStatusCoded>ProcessFatalError</DocumentStatusCoded>
  </ApplicationResponseHeader><ListOfApplicationResponseDetail>
  <ApplicationResponseDetail>
    <ErrorTypeCoded>PayloadError</ErrorTypeCoded>
    <ErrorInfo>
    <core:CompletionText>An error code</core:CompletionText>
    <core:CompletionMsg>
      <core:LangString>The error text</core:LangString>
      <core:Language>
      <core:LanguageCoded>en</core:LanguageCoded>
      </core:Language>
    </core:CompletionMsg>
    <core:Severity>
      <core:SeverityCoded>Error</core:SeverityCoded>
    </core:Severity>
    </ErrorInfo>
  </ApplicationResponseDetail>
  </ListOfApplicationResponseDetail>
</ApplicationResponse>
```

The following is an example of an error response, which may be generated to indicate a system problem, indicating that a configurable number of retries may be warranted. In this example, the document status code is “FatalError” and the error type code is “BusyError”:

```
<ApplicationResponse >
  <ApplicationResponseHeader>
  <ApplicationResponseIssueDate>2005-05-02T13:20:00-
05:01</ApplicationResponseIssueDate>
  <ApplicationResponseTypeCoded>Error-
  </ApplicationResponseTypeCoded>
    <ApplicationResponseSender>
    <core:PartyID>
    <core:Ident>Company “A”</core:Ident>
    </core:PartyID><core:ListOfIdentifier>
    <core:Identifier>
      <core:Ident>234985340834</core:Ident>
    </core:Identifier>
    </core:ListOfIdentifier>
  </ApplicationResponseSender>
  <ApplicationResponseReceiver>
    <core:PartyID>
    <core:Ident>SPMS, Inc.</core:Ident>
    </core:PartyID>
  </ApplicationResponseReceiver>
  <BusinessDocumentTypeCoded>Requisition-
  </BusinessDocumentTypeCoded>
  <DocumentReference>
    <core:RefNum>234879234</core:RefNum>
  </DocumentReference>
  <DocumentStatusCoded>FatalError</DocumentStatusCoded>
  </ApplicationResponseHeader><ListOfApplicationResponseDetail>
  <ApplicationResponseDetail>
    <ErrorTypeCoded>BusinessError</ErrorTypeCoded>
    <ErrorInfo>
    <core:CompletionText>An error code</core:CompletionText>
    <core:CompletionMsg>
      <core:LangString>The error text</core:LangString>
      <core:Language>
      <core:LanguageCoded>en</core:LanguageCoded>
      </core:Language>
    </core:CompletionMsg>
    <core:Severity>
      <core:SeverityCoded>Error</core:SeverityCoded>
    </core:Severity>
    </ErrorInfo>
  </ApplicationResponseDetail>
  </ListOfApplicationResponseDetail>
</ApplicationResponse>
```

The following is an example of an error response, which may be generated to indicate software coding errors. In this example, the error type code is “Other” and the error type coded value is “Unknown”. Explanatory text may be included and may be logged to help resolve the issue:

```
<ApplicationResponse>
  <ApplicationResponseHeader>
  <ApplicationResponseIssueDate>2005-05-02T13:20:00-
05:01</ApplicationResponseIssueDate>
  <ApplicationResponseTypeCoded>Error-
  </ApplicationResponseTypeCoded>
  <ApplicationResponseSender>
    <core:PartyID>
    <core:Ident>Company “A”</core:Ident>
    </core:PartyID>
    <core:ListOfIdentifier>
    <core:Identifier>
      <core:Ident>234985340834</core:Ident>
    </core:Identifier>
    </core:ListOfIdentifier>
  </ApplicationResponseSender>
  <ApplicationResponseReceiver>
    <core:PartyID>
    <core:Ident>SPMS, Inc.</core:Ident>
    </core:PartyID>
  </ApplicationResponseReceiver>
  <BusinessDocumentTypeCoded>Requisition-
  </BusinessDocumentTypeCoded>
  <DocumentReference>
    <core:RefNum>234879234</core:RefNum>
  </DocumentReference>
  <DocumentStatusCoded>FatalError</DocumentStatusCoded>
  </ApplicationResponseHeader>
  <ListOfApplicationResponseDetail>
  <ApplicationResponseDetail>
    <ErrorTypeCoded>Other</ErrorTypeCoded>
    <ErrorTypeCodedOther>Unknown</ErrorTypeCodedOther>
    <ErrorInfo>
    <core:CompletionText>An error code</core:CompletionText>
    <core:CompletionMsg>
      <core:LangString>The error text</core:LangString>
      <core:Language>
      <core:LanguageCoded>en</core:LanguageCoded>
      </core:Language>
    </core:CompletionMsg>
    <core:Severity>
      <core:SeverityCoded>Error</core:SeverityCoded>
    </core:Severity>
    </ErrorInfo>
  </ApplicationResponseDetail>
  </ListOfApplicationResponseDetail>
</ApplicationResponse>
```

### Subscription Cancellation

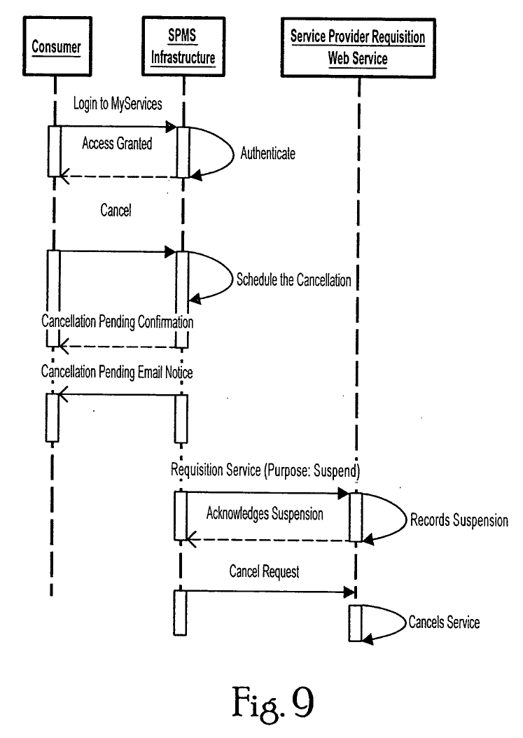

Cancellation may be initiated by either subscriber/consumer 104 or SPMS server 105 in the case of non-payment or fraud. An example of cancellation scenario is described below, and in reference to FIG. 9.

The subscriber/consumer 104 initiates a cancel request. The subscriber/consumer 104 is notified, e.g., via email that the service is pending cancellation, at the end of the pre-paid period. After the pre-paid period lapses, a suspension requisition may be sent by the SPMS server 105 to the supplier 101. SPMS server 105 may then notify the subscriber/consumer 104 that his subscription has ended.

### Supplier Download or Registration Page

An email notification may be sent to the subscriber/consumer 104 after the completion of purchase. The email may contain links that allow the consumer to visit the supplier's web site and download/configure the purchased services. The links may be dynamically created based on the requirements of the supplier and may typically contain GET parameters that permit the supplier to check the authenticity of the request.

The URL string may include the URL encoded account number (AN), the Supplier SKU (CQU), the user ID (LUID), and the email address (EA). There may be various other optional parameters that may be sent, depending on the supplier's requirements.

A typical URL string might be formatted in the following example fashion:

http://myfavoriteserviceprovider.com?CQU=1234&AN=1234&EA=
bob%40gwu%2eedu &LUID=1234

When the subscriber/consumer 104 visits the supplier's account set-up or download page, the supplier may parse the parameters and authorize the subscriber/consumer 104 to proceed with set-up or download based on the record created with the previous requisition from SPMS server 105.

### Supplier Links to SPMS for Customer Support

The following are three examples of the links, which may be provided to suppliers 101 for use within frames on their customer support pages. These links may allow the subscriber/consumers 104 to cancel their accounts, upgrade the level of service, or manage their account information established with the supplier 101. The links may cause a redirect to occur, sending the customer to the proper merchant allowing the customer to perform the desired action.

http://tryandbuy.com/direct/cancel.aspx
http://tryandbuy.com/direct/upgrade.aspx
http://tryandbuy.com/direct/account.aspx

Each of these URLs may require an URL parameter describing the customer's subscription's account number provided to the supplier 101 during the requisition, e.g., in the following form:

http://tryandbuy.com/direct/account.aspx?AN=account_number

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described embodiments.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Finally, it is the applicant's intent that only claims that include the express language “means for” or “step for” be interpreted under 35 U.S.C. §112, paragraph 6. Claims that do not expressly include the phrase “means for” or “step for” are not to be interpreted under 35 U.S.C. §112, paragraph 6.

### APPENDIX

Distributor Integration Web Services Schema
<?xml version=“1.0” encoding=“utf-8”?>
<definitions
xmlns:s1=“http://www.arpuinc.com/schemas/PremiumServices/v1_0/merchantIntegration
/v1_0/merchantintegration.xsd” xmlns:http=“http://schemas.xmlsoap.org/wsdl/http/”
xmlns:soap=“http://schemas.xmlsoap.org/wsdl/soap/”
xmlns:s=“http://www.w3.org/2001/XMLSchema”
xmlns:s0=“http://www.arpuinc.com/PremiumServices/v1_0/MerchantIntegration/v1_0/Merchant
Integration.wsdl” xmlns:s2=“http://www.w3.org/2000/09/xmldsig#”
xmlns:soapenc=“http://schemas.xmlsoap.org/soap/encoding/”
xmlns:tm=“http://microsoft.com/wsdl/mime/textMatching/”
xmlns:mime=“http://schemas.xmlsoap.org/wsdl/mime/”
targetNamespace=“http://www.arpuinc.com/PremiumServices/v1_0/MerchantIntegration
/v1_0/MerchantIntegration.wsdl” xmlns=“http://schemas.xmlsoap.org/wsdl/”>
<types>
<s:schema elementFormDefault=“qualified”
targetNamespace=“http://www.arpuinc.com/PremiumServices/v1_0/MerchantIntegration
/v1_0/MerchantIntegration.wsdl”>
<s:import
namespace=“http://www.arpuinc.com/schemas/PremiumServices/v1_0/merchantIntegration
/v1_0/merchantintegration.xsd” schemaLocation=“merchantintegration.xsd”/>
<s:import namespace=“http://www.w3.org/2000/09/xmldsig#”
schemaLocation=“http://www.w3.org/TR/2002/REC-xmldsig-core-20020212/xmldsig-
core-schema.xsd”/>
<s:element name=“requestCustomerInfo”>
<s:complexType>
<s:sequence>
<s:element minOccurs=“0” maxOccurs=“1” ref=“s1:CustomerInformationRequest”/>
</s:sequence>
</s:complexType>
</s:element>
<s:element name=“requestCustomerInfoResponse”>
<s:complexType>
<s:sequence>
<s:element minOccurs=“0” maxOccurs=“1” ref=“s1:CustomerInformationResponse”/>
</s:sequence>
</s:complexType>
</s:element>
</s:schema>
</types>
<message name=“requestCustomerInfoSoapIn”>
<part name=“parameters” element=“s0:requestCustomerInfo”/>
</message>
<message name=“requestCustomerInfoSoapOut”>
<part name=“parameters” element=“s0:requestCustomerInfoResponse”/>
</message>
<portType name=“MerchantIntegrationSoap”>
<operation name=“requestCustomerInfo”>
<input message=“s0:requestCustomerInfoSoapIn”/>
<output message=“s0:requestCustomerInfoSoapOut”/>
</operation>
</portType>
<binding name=“MerchantIntegrationSoap” type=“s0:MerchantIntegrationSoap”>
<soap:binding transport=“http://schemas.xmlsoap.org/soap/http” style=“document”/>
<operation name=“requestCustomerInfo”>
<soap:operation
soapAction=“http://www.arpuinc.com/PremiumServices/v1_0/MerchantIntegration/v1_0/
MerchantIntegration.wsdl/requestCustomerInfo” style=“document”/>
<input>
<soap:body use=“literal”/>
</input>
<output>
<soap:body use=“literal”/>
</output>
</operation>
</binding>
<service name=“MerchantIntegration”>
<port name=“MerchantIntegrationSoap” binding=“s0:MerchantIntegrationSoap”>
<soap:address
location=“http://localhost/development/MerchantIntegration/MerchantIntegration.asmx”/>
</port>
</service>
</definitions>
Distributor Integration Schema
<?xml version=“1.0” encoding=“utf-8”?>
<xs:schema
xmlns:tns=“http://www.arpuinc.com/schemas/PremiumServices/v1_0/merchantIntegration
/v1_0/merchantintegration.xsd” xmlns:xs=“http://www.w3.org/2001/XMLSchema”
xmlns:q1=“http://www.w3.org/2000/09/xmldsig#”
targetNamespace=“http://www.arpuinc.com/schemas/premiumServices/v1_0/merchantIntegration
/v1_0/merchantintegration.xsd” elementFormDefault=“qualified”>
<xs:import namespace=“http://www.w3.org/2000/09/xmldsig#”
schemaLocation=“http://www.w3.org/TR/2002/REC-xmldsig-core-20020212/xmldsig-
core-schema.xsd”/>
<xs:element name=“CustomerInformationRequest”
type=“tns:CustomerInformationRequestType”/>
<xs:complexType name=“CustomerInformationRequestType”>
<xs:sequence>
<xs:element name=“SessionId” type=“xs:string” minOccurs=“0”/>
<xs:element name=“TimeStamp” type=“xs:dateTime”/>
<xs:element name=“BuyerId” type=“xs:string” minOccurs=“0”/>
<xs:element name=“ReferrerInfo” type=“xs:string” minOccurs=“0”/>
<xs:element name=“Signature” type=“q1:SignatureType” minOccurs=“0”/>
</xs:sequence>
</xs:complexType>
<xs:element name=“CustomerInformationResponse”
type=“tns:CustomerInformationResponseType”/>
<xs:complexType name=“CustomerInformationResponseType”>
<xs:sequence>
<xs:element name=“CustomerInfo” type=“tns:CustomerInformationType”
minOccurs=“0”/>
<xs:element name=“ErrorInfo” type=“tns:MerchantIntegrationErrorType”
minOccurs=“0”/>
</xs:sequence>
</xs:complexType>
<xs:complexType name=“CustomerInformationType”>
<xs:sequence>
<xs:element name=“UserName” type=“xs:string” minOccurs=“0”/>
<xs:element name=“PaymentInstrumentInfo” type=“tns:PaymentInstrumentInfoType”/>
<xs:element name=“EmailAddress” type=“xs:string” minOccurs=“0”/>
<xs:element name=“BillingAddress” type=“tns:AddressType”/>
<xs:element name=“ShippingAddress” type=“tns:AddressType” minOccurs=“0”/>
</xs:sequence>
</xs:complexType>
<xs:complexType name=“PaymentInstrumentInfoType”>
<xs:sequence>
<xs:element name=“NameOnCard” type=“xs:string”/>
<xs:element name=“CardNumber” type=“xs:string”/>
<xs:element name=“SecurityCode” type=“xs:string” minOccurs=“0”/>
<xs:element name=“ExpirationMonth” type=“xs:int”/>
<xs:element name=“ExpirationYear” type=“xs:int”/>
<xs:element name=“IsDebit” type=“xs:boolean”/>
</xs:sequence>
</xs:complexType>
<xs:complexType name=“AddressType”>
<xs:sequence>
<xs:element name=“FirstName” type=“xs:string” minOccurs=“0”/>
<xs:element name=“LastName” type=“xs:string” minOccurs=“0”/>
<xs:element name=“Address1” type=“xs:string”/>
<xs:element name=“Address2” type=“xs:string”/>
<xs:element name=“City” type=“xs:string”/>
<xs:element name=“StateOrProvince” type=“xs:string”/>
<xs:element name=“Country” type=“xs:string”/>
<xs:element name=“PostalCode” type=“xs:string”/>
<xs:element name=“Phone” type=“xs:string” minOccurs=“0”/>
</xs:sequence>
</xs:complexType>
<xs:complexType name=“MerchantIntegrationErrorType”>
<xs:sequence>
<xs:element name=“ErrorCode” type=“tns:ErrorCodeType”/>
<xs:element name=“ErrorText” type=“xs:string” minOccurs=“0”/>
</xs:sequence>
</xs:complexType>
<xs:simpleType name=“ErrorCodeType”>
<xs:restriction base=“xs:string”>
<xs:enumeration value=“Fatal”/>
<xs:enumeration value=“Transient”/>
<xs:enumeration value=“Unknown”/>
</xs:restriction>
</xs:simpleType>
</xs:schema>

### Implementation Project Plan Example

Distributor Milestones

| Milestone | Description |
|---|---|
| Analysis | Collect all requirements. |
| Purchase confirmation page | Design solution for placement of SPMS |
| design | cross-sell frame in purchase confirmation |
| | page. |
| Purchase confirmation page | Create purchase confirmation page |
| implementation | with SPMS cross-sell frame generation. |
| Purchase confirmation | Create QA test plans. |
| page test | QA verifies SPMS Frameset is generated |
| | according to specifications. |
| Purchase confirmation page | Set up cross-site integration |
| integration | facility configurations. |
| | Develop integration test plans. |
| | Verify site-to-site connectivity. |
| | Execute integration test plans. |
| Purchase page deployment | Develop deployment document. |
| | Push to production from staging area. |
| | Verify deployment. |
| Distributor Integration Web | Design solution for web service |
| Service design | which provides SPMS with |
| | customer billing information. |
| Distributor Integration Web | Implement web service business |
| Service development | logic to retrieve customer information. |
| Distributor Integration Web | Create QA test plan. |
| Service test | QA verifies web service operates |
| | according to |
| | specification. |
| Distributor Integration Web | Create integration plan. |
| Service integration | Execute integration test. |
| Distributor Integration Web | Develop deployment document. |
| Service deployment | Push to production. |
| | Verify proper deployment |
| | configuration. |

Supplier Milestones

| Milestone | Description |
|---|---|
| Analysis | Collect requirements. |
| Requisition web service design | Design the component that accepts arpu order and |
| | suspend requisitions. |
| Requisition web service | Develop the web service. |
| development | |
| Requisition web service QA | Develop QA test plan. |
| test | Execute QA test cases. |
| Requisition web service | Configure site-to-site connectivity. |
| integration test | Verify connectivity. |
| | Develop integration test plan. |
| | Execute integration test cases. |
| Requisition web service | Create deployment document. |
| production deployment | Deploy web service. |
| | Verify proper deployment |
| Registration page design | Design page to accept SPMS customers and parse |
| | URL string parameters, verifying them against the |
| | customer database. |
| Registration page development | Develop code to parse SPMS URL string parameters |
| | and verify them against the customer database. |
| Registration page QA test | Develop QA test plan. |
| | Execute QA test cases. |
| Registration page integration | Configure integration environment. |
| test | Develop integration test plan. |
| | Execute integration test cases. |
| Registration page production | Deploy Registration pages according to deployment |
| deployment | document. |
| | Verify proper deployment. |
| UI modifications design | Identify and design all pages that require |
| | modifications restricting access to SPMS customers, |
| | including certain help, billing, and service tier |
| | change pages. |
| UI modifications development | Develop UI changes. |
| UI modifications test | Develop QA test plan. |
| | Execut QA test cases. |
| UI modifications deployment | Deploy modified pages according to deployment plan. |
| | Verify deployment. |

We claim:

1. A computer implemented method of managing customer accounts, comprising:
providing an electronic database of a plurality of customer account records, said plurality of customer account records including at least a first record and a second record, said first record being associated with a first account, said first account relating to first patronage activity of a first customer with a first third party supplier, said second record being associated with a second account, said second account relating to second patronage activity of said first customer with a second third party supplier, said first third party supplier and said second third party supplier being different from each other;
providing a user interface accessible through a computer network, said user interface allowing said first customer to make a first modification, said first modification being made to said first record in said electronic database; and
notifying through said computer network said first third party supplier of said first modification.

2. The computer implemented method of managing customer accounts as set forth in claim 1, further comprising:
allowing said first customer to make a choice between making said first modification and making a second modification, said second modification being made to said second record; and
if said first customer modifies said second record, notifying through said computer network said second third party supplier of said second modification.

3. The computer implemented method of managing customer accounts as set forth in claim 2, wherein said allowing said first customer to make said choice comprises:
displaying a menu, from which a selection of one from at least said first account and said second account.

4. The computer implemented method of managing customer accounts as set forth in claim 1, wherein:
said first patronage activity comprises said first customer having a first subscription to at least one of a subscription based product and a subscription based service offered said first third party supplier.

5. The computer implemented method of managing customer accounts as set forth in claim 4, wherein:
said first record is created to record a purchase by said first customer of said subscription; and
wherein said first modification is made as a part of a process for said purchase.

6. The computer implemented method of managing customer accounts as set forth in claim 4, wherein:
said first record contains a billing information, said billing information including a source of fund from which payment is to be made for said at least one of said subscription based product and said subscription based service.

7. The computer implemented method of managing customer accounts as set forth in claim 4, wherein:
said first record contains an active status, wherein said first modification changes said active status to a canceled status.

8. The computer implemented method of managing customer accounts as set forth in claim 4, wherein:
said first record contains information relating to a level of service to be received by said first customer, wherein said first modification changes said level of service from one level to another level from among a plurality of differing levels of service.

9. The computer implemented method of managing customer accounts as set forth in claim 4, wherein said second patronage activity comprises said first customer having a second subscription to at least one of a subscription based product and a subscription based service offered by said second third party supplier, said method further comprising:
determining a first subscription fee to be paid by said first customer for said first subscription;
determining a second subscription fee to be paid by said first customer for said second subscription; and
presenting a combined sum of said first subscription fee and said second subscription fee together as a combined payment amount.

10. The computer implemented method of managing customer accounts as set forth in claim 9, wherein said presenting comprises:
providing an invoice showing said combined payment amount to said first customer.

11. The computer implemented method of managing customer accounts as set forth in claim 10, further comprising:
collecting from said first customer said first subscription fee and said a second subscription fee together in a single collection.

12. The computer implemented method of managing customer accounts as set forth in claim 11, wherein said collecting comprises:
charging a combined sum of said first subscription fee and said second subscription fee as a single charge to a credit card of said first subscriber.

13. A system for managing customer accounts, comprising:
a database having stored therein a plurality of customer account records, said plurality of customer account records including at least a first record and a second record, said first record being associated with a first account, said first account relating to a first patronage activity of a first customer with a first third party supplier, said second record being associated with a second account, said second account relating to a second patronage activity of said first customer with a second third party supplier, said first third party supplier and said second third party supplier being different from each other; and
a web server in communicative connection with said database, said web server being in communicative connection through a network with said first customer, said web server being configured to receive an indication from said first customer for a first modification to be made to said first record; and said web server being configured to notifying said first third party supplier of said first indication over said network.

14. The system for managing customer accounts according to claim 13, wherein:
said web server is further configured to provide a user interface accessible by said first customer, said user interface including a menu of a plurality of selectable items, a first one of said plurality of selectable items, when selected, allowing said first customer to make said first modification, a second one of said plurality of selectable items, when selected, allowing said first customer to make a second modification, said second modification being made to said second record.

15. The system for managing customer accounts according to claim 14, wherein:
said first patronage activity comprises said first customer having a first subscription to at least one of a subscription based product and a subscription based service offered said first third party supplier.

16. The system for managing customer accounts according to claim 15, wherein said second patronage activity comprises said first customer having a second subscription to at least one of a subscription based product and a subscription based service offered by said second third party supplier, wherein:
said web server is configured to provide an invoice to said first customer, said invoice showing a combined payment amount of a first subscription fee to be paid by said first customer for said first subscription and a second subscription fee to be paid by said first customer for said second subscription.

17. The system for managing customer accounts according to claim 13, wherein:
said first record contains a billing information, said billing information including a source of fund from which payment is to be made for said at least one of said subscription based product and said subscription based service.

18. The system for managing customer accounts according to claim 13, wherein:
said first record contains an active status, wherein said first modification changes said active status to a canceled status.

19. The system for managing customer accounts according to claim 13, wherein:
said first record contains information relating to a level of service to be received by said first customer, wherein said first modification changes said level of service from one level to another level among a plurality of differing levels of service.

20. The system for managing subscription accounts according to claim 16, wherein:
said web server is configured to collect a single payment by charging the combined payment amount as a single charge to a credit card of said first customer.

21. A computer implemented method of facilitating an electronic commerce transaction, comprising:
receiving, at a promotion server, through a computer communication network, from a first seller a first indication of a purchase of a first product by a customer from said first seller, said indication including a first product information, said first product information being capable of being used to identify said first product;
sending by said promotion server over said computer communication network an offer for a second product of a second seller to said first seller;
receiving by said promotion server over said computer communication network from said first seller a second indication that said customer desires to purchase said second product; and
allowing said customer to purchase said second product without requiring said customer to provide billing information of said customer to said second seller.

22. The computer implemented method of facilitating said electronic commerce transaction as set forth in claim 21, further comprising:
selecting said second product from a plurality of products based on said first product information.

23. The computer implemented method of facilitating said electronic commerce transaction as set forth in claim 21, wherein:
said first product information comprises stock keeping unit (SKU) number for said first product.

24. The computer implemented method of facilitating said electronic commerce transaction as set forth in claim 23, wherein:
said first product information further comprises a zone improvement plan (ZIP) code of an address of said customer.

25. The computer implemented method of facilitating said electronic commerce transaction as set forth in claim 22, wherein said selecting said second product further comprises:
choosing from a catalog of products said second product that was historically also purchased by past customers who have purchased said first product.

26. The computer implemented method of facilitating said electronic commerce transaction as set forth in claim 21, further comprising:
sending over said computer communication network a purchase requisition to said second seller for said second product; and
receiving from said second seller an acknowledgement of said purchase requisition.

27. The computer implemented method of facilitating said electronic commerce transaction as set forth in claim 26, wherein:
said purchase requisition comprises a message encoded using Extensible Markup Language (XML).

28. The computer implemented method of facilitating said electronic commerce transaction as set forth in claim 26, wherein:
said purchase requisition comprises a Simple Object Access Protocol (SOAP) message.

29. The computer implemented method of facilitating said electronic commerce transaction as set forth in claim 26, further comprising:
sending a message to said customer, said message including a product activation information, said product activation information being capable of being used by said customer to activate said second product.

30. The computer implemented method of facilitating said electronic commerce transaction as set forth in claim 26, wherein:
said purchase requisition includes a second product information, a customer identification, said second product information being capable of being used to identify said second product, said customer identification being capable of being used to identify said customer, and
wherein said product activation information comprises a hyperlink directing said customer to a website of said second seller, said hyperlink containing said customer identification.

31. The computer implemented method of facilitating said electronic commerce transaction as set forth in claim 21, further comprising:
sending a request for said billing information to said first seller;
receiving from said first seller said billing information;
combining prices for said first product and said second product as a combined price; and
presenting said combined price to said customer.

32. The computer implemented method of facilitating said electronic commerce transaction as set forth in claim 21, wherein:
said first indication is a message containing at least one parameters specifying a embedded frame of a purchase confirmation web page of said first seller, and
wherein said offer for a second product is a hyper text markup language (HTML) rendering to be incorporated in said embedded frame.

33. A system for facilitating an electronic commerce transaction, comprising:
at least one communication interface configured to receive over a computer communication network from a first seller a first indication of a purchase of a first product by a customer from said first seller, said indication including a first product information, said first product information being capable of being used to identify said first product;
a promotion engine configured to select a second product of a second seller from a plurality of cataloged products based on said first product information, said at least one communication interface configured to send an offer for said second product through said at least one communication interface, and to receive from said first seller a second indication that said customer desires to purchase said second product; and
a transaction engine configured to allow said customer to purchase said second product without requiring said customer to provide billing information of said customer to said second seller.

34. The system for facilitating said electronic commerce transaction according to claim 33, wherein:
said first product information comprises stock keeping unit (SKU) number for said first product.

35. The system for facilitating said electronic commerce transaction according to claim 33, wherein:
said first product information further comprises a zone improvement plan (ZIP) code of an address of said customer.

36. The system for facilitating said electronic commerce transaction according to claim 33, wherein:
said transaction engine is further configured to issue a purchase requisition for said second product to said second seller, and to receiving from said second seller an acknowledgement of said purchase requisition.

37. The system for facilitating said electronic commerce transaction according to claim 36, wherein:
said purchase requisition comprises a message encoded using Extensible Markup Language (XML).

38. The system for facilitating said electronic commerce transaction according to claim 36, wherein:
said purchase requisition comprises a Simple Object Access Protocol (SOAP) message.

39. The system for facilitating said electronic commerce transaction according to claim 33, wherein:
said transaction engine is configured to send through said at least one communication interface a message to said customer, said message including a product activation information, said product activation information being capable of being used by said customer to activate said second product.

40. The system for facilitating said electronic commerce transaction according to claim 36, wherein:
said purchase requisition includes a second product information, a customer identification, said second product information being capable of being used to identify said second product, said customer identification being capable of being used to identify said customer, and
wherein said product activation information comprises a hyperlink directing said customer to a website of said second seller, said hyperlink containing said customer identification.

41. The system for facilitating said electronic commerce transaction according to claim 33, wherein:
said transaction engine is configured to send through said at least one communication interface a request for said billing information to said first seller, and to receive through said at least one communication interface from said first seller said billing information, and
wherein said transaction engine is further configured to combine prices for said first product and said second product as a combined price, and to present said combined price to said customer.

42. The system for facilitating said electronic commerce transaction according to claim 33, wherein:
said first indication is a message containing at least one parameters specifying a embedded frame of a purchase confirmation web page of said first seller, and
wherein said offer for a second product is a hyper text markup language (HTML) rendering to be incorporated in said embedded frame.
